(19) United States
(12) Patent Application Publication
(10) Pub. No.: US 2006/0274872 A1
(43) Pub. Date: Dec. 7, 2006

(54) Waveform shaping method, waveform shaping device, electronic device, waveform shaping program and recording medium

(76) Inventors: Yutaka Ikeda, Osaka (JP); Takashi Aramaki, Chiba (JP)

Correspondence Address: BIRCH STEWART KOLASCH & BIRCH, PO BOX 747, FALLS CHURCH, VA, 22040-0747, US

(21) Appl. No.: 10/552,454

(22) PCT Filed: Mar. 19, 2004
(86) PCT No.: PCT/JP04/03812

§ 371 Date: Oct. 7, 2005

(30) Foreign Application Priority Data
Apr. 9, 2003 (JP) 2003-105461
Dec. 26, 2003 (JP) 2003-432559

(51) Int. Cl. H04L 7/00

(52) U.S. Cl. 375/355

(57) ABSTRACT

A sampling section (102) is provided for generating a sampling signal (103) by sampling an input signal (101) using a sampling clock (106) which is faster than a data speed of the input signal (101). A waveform shaping section (104) is provided for I) processing (e.g. inverting a pulse) the sampling signal (103), so as to shape a restored digital signal obtained from a pulse of the input signal (101), and II) outputting the restored digital signal as an output signal (105). In this way, it becomes possible to provide: A) a waveform shaping method and a waveform shaping device, each of which is capable of correcting distortion in an input signal by means of a simple method or configuration; B) a waveform shaping program that realizes the waveform shaping method or the waveform shaping device; and C) a recording medium storing therein the waveform shaping program.

### TECHNICAL FIELD

The present invention relates to a waveform shaping method, a waveform shaping device, and an electronic device for (i) appropriately restoring and reproducing an original digital signal or (ii) acquiring an appropriate process result as is acquired by directly processing the original signal, despite a distortion in a waveform of a pulse train constituting the original signal. The present invention also relates to a waveform shaping program for realizing, in a computer, a function of the waveform shaping method, the waveform shaping device, or the electronic device, and relates to a recording medium storing therein such a waveform shaping program.

### BACKGROUND ART

In general, a remote control (remote controlling device) is used for remotely controlling a television, a video player or the like. Meanwhile, various businesses are engaged in producing a wireless television. For example, Toshiba corp. has placed wireless televisions on the market having model numbers 20LF10 and 14LF10. Further, Casio Computer Co., LTD. has placed wireless televisions on the market having model numbers XF800 and XF-600.

In the case of a wireless television, it is necessary to devise a wireless remote control to enable such a television to be controlled remotely by using the remote control.

For example, as illustrated in FIG. 22, a television viewer uses a remote control 209, directing the remote control 209 towards a television 207. However, it is not the television 207 which is actually operated upon reception of a remote-control signal, but a transmission-side tuner 202 or the like having a wireless connection to the television 207.

A specific structure is as follows. Namely, an electric wave of a television broadcast is received by an antenna 201. The electric wave is then inputted to the tuner 202, and is reproduced. On the other hand, the user who is viewing the television operates the remote control 209, directing the remote control 209 towards the television 207, thereby transmitting an infrared signal 208 containing a remote-control signal. The television 207 having received the infrared signal 208 carries out a wireless transmission of a control signal 206, containing the remote-control signal, to a wireless station 204. The wireless station 204, having received the control signal 206, reproduces the infrared signal 208, and outputs the infrared signal 208 from an infrared emitting section 203, thereby controlling the tuner 202.

As a result, a controlled video signal 205 is transmitted from the wireless station 204 to the television 207, thus enabling viewing of the video signal 205 which is reproduced on the television 207. This structure is referred to as “Remote controller pass through function” by Toshiba corp. (See non-patent document 1: “Toshiba: FACE”, published by Toshiba corp., URL: http://www.toshiba.co.jp/product/tv/ekisyou.html/ [As of: Jan. 16, 2003]).

In short, there is a need for a structure which transmits the remote-control signal from the television 207 to the tuner 202, the television 207 serving as a receiver for receiving the video signal transmitted in a wireless manner, the tuner 202 serving as a transmitter for transmitting the video signal in the wireless manner.

FIG. 23 illustrates an example of a main part of such a structure. An infrared receiving section 301 of the television 207 receives the infrared signal from the remote control 209. The signal being received is sampled in a sampling section 302, and is transmitted, as a sampling signal, from a sampling signal transmitting section 303 to the wireless station 204. The sampling signal received by a sampling signal receiving section 304 of the wireless station 204 is reproduced as a remote-control signal in the remote-control signal reproducing section 305. This remote-control signal is transmitted from the infrared emitting section 306 to the tuner 202.

Each of FIG. 24(a) to FIG. 24(h) illustrates a state of the signal in each of the main parts of the structure. In general, in an original signal 401 to be inputted to the infrared receiving section 301, a remote control signal which is data of “0” and “1,” is multiplied by a carrier wave. Incidentally, a frequency of the carrier wave used in a typical remote control is approximately 36 kHz to 40 kHz.

When the original signal 401 is inputted to the infrared receiving section 301, the original signal 401 is subject to a detection. The carrier wave is removed from the original signal 401 by the detection, thereby converting the original signal 401 into an infrared-receiving-section output signal 402. Next, when the infrared-receiving-section output signal 402 is inputted to the sampling section 302, the infrared-receiving-section output signal 402 is sampled (sampling step 403) at a frequency faster than speed of the original remote-control signal. Thus, the sampling signal 404 is generated.

The sampling signal 404 is transmitted, in a wireless manner, from the sampling signal transmitting section 303 to the wireless station 204. Then, in the sampling signal receiving section 304, the sampling signal 404 is reproduced as the sampling signal 405. The sampling signal 405 is reproduced in the remote-controller reproducing section 305 (reproducing step 406), thus generating an infrared-emitting-section input signal 407. Next, in the infrared emitting section 306, the infrared-emitting-section input signal 407 is multiplied by a carrier wave of a desirable frequency, and is transmitted as a reproduced signal 408 to the tuner 202.

As described, the wireless station 204 restores and reproduces the sampling signal 405 from the sampling signal 404, which is transmitted in a wireless manner. The sampling signal 405 is then transmitted to the tuner 202. This allows remote-control of the television 207 using the remote control 209.

However, as illustrated in FIG. 25, it is widely known that a trailing edge of an output pulse 2002 (corresponding to the infrared-receiving-section output signal 402) from the infrared receiving section 301 stretches, and that the output pulse 2002 therefor has a wider pulse width than a pulse width of an input pulse 2001 (corresponding to a pulse width of the original signal 401) (See Patent document 1: Japanese Unexamined Patent Application No. 145184/2001 (Tokukai 2001-145184; published on May 25, 2001)). This distortion in the waveform is attributed to characteristics of the infrared receiving section 301 in which the original signal 401 is subject to photoelectric transfer.

More specifically, the waveform of the infrared-receiving-section signal 402 is distorted through the photoelectric transfer carried out in the infrared receiving section 301. For this reason, in the wireless station 204, the original signal 401 can not be restored through the light-to-current transfer carried out in the infrared emitting section 306. Accordingly, if nothing is done, other than merely carrying out the sampling process, a waveform of the reproduced signal 408 reproduced in the wireless station 204 is inevitably stretched wider than the waveform initially outputted from the remote control 209, no matter how fast the sampling is carried out. As a result, the wireless video transfer system may malfunction, or the system may not operate.

Note that there is a suggested technology for solving the problem (See paragraph 0031 to 0032 of Patent document 1).

However, in a case where a pulse of the remote-control signal is shaped by using the conventional technology (Patent document 1), the following problem is left to be solved. With the technology disclosed in Patent document 1, the pulse outputted from the infrared receiving section 301 can be shaped so that the waveform becomes close to the originally intended waveform. However, various manufacturers around the world are placing infrared receiving sections 301 on the market, having various photoelectric transfer characteristics. Further, there are already a considerable number of infrared receiving sections 301 on the market.

Further, there are a plurality of design conditions such as frequency band, power source voltage, and wave length. Under such circumstances, there are many cases where it is difficult to solve the foregoing problem by merely applying the technology of Patent document 1 to the infrared receiving section 301; e.g., a case where a pulse needs to be shaped, while continuing to use a conventional infrared receiving section as the infrared receiving section 301.

In view of the foregoing problems, is the present invention has the objects of providing: (A) a waveform shaping method or a waveform shaping device which (i) enables a waveform to be shaped into a shape that is closer to its original shape, and (ii) simplifies a waveform shaping technology, while continuing to use, as the infrared receiving section 301, a conventionally-used product whose input pulse width and output pulse width are different from each other; (B) a waveform shaping program functioning according to the waveform shaping method and the waveform shaping device; and (C) a recording medium storing therein the waveform shaping program.

### DISCLOSURE OF INVENTION

(1) In order to achieve the foregoing object, a waveform shaping method of the present invention includes: a sampling step for generating a sampling signal by sampling an input signal using a sampling clock which is faster than a data speed of the input signal; and a waveform shaping step for processing the sampling signal, so that a pulse in the input signal, recognized from the sampling signal, is shaped.

The waveform shaping method may be so adapted that, in the waveform shaping step, waveform shaping is carried out by partially inverting bit string data of the sampling signal.

The description reading “sampling an input signal using a sampling clock which is faster than a data speed of the input signal” means a process in which the input signal is replaced with a discrete symbol string by sampling the input signal at a sampling period which is shorter than a minimum value of a meaningful waveform changing period (e.g., a minimum pulse width of a pulse in the pulse signal in the case where the input signal is the pulse signal) of the input signal. Note that the description reading “a sampling clock which is faster than a data speed of the input signal” may be rephrased as “a sampling clock which, in comparison to a data speed of the input signal, is fast, but not so fast that a sampling error occurs” or “a sampling clock whose frequency is double or more of a maximum effective frequency in the input signal”. With the use of such a sampling clock for sampling the input signal, the input signal is properly restored while preventing a sampling error (or aliasing).

In the configuration, a sampling signal is generated by sampling the input signal using the sampling clock whose speed is faster than a data speed of the input signal. In this way, a single pulse of the input signal can be indicated by plural symbols of the sampling signal. Further, it is possible to prevent information contained in the input signal from being omitted. In other words, the sampling signal can be so generated that the information is accurately restored. Further, even if a waveform of a pulse is distorted during its transmission, the distortion is reduced in the sampling signal converted from the distorted pulse.

Further, in the foregoing method, the pulse of the input signal is shaped by processing the sampling signal. As such, for example, the shaping of the pulse can be done using a simple method in which the number of symbols, in the sampling signal, corresponding to the pulse, is increased or decreased, reducing the level of distortion in the sampling signal. Accordingly, in the foregoing method, the original input signal is more accurately regenerated and restored through the waveform shaping.

(2) The foregoing waveform shaping method may be so adapted that, when the input signal is a pulse signal generated through a signal processing carried out with respect to an original pulse signal on which the input signal is based, in the waveform shaping step, waveform shaping is carried out by making a pulse width, which is recognized from the sampling signal, of the input signal closer to a predetermined pulse width.

Incidentally, a digital signal such as a remote control signal is generated based on information of the original signal. In some cases of using such a digital signal, a pulse width is fixed, and information is transmitted by using a pulse interval (fixed-pulse-width method). In this case, even if the pulse width of the input signal is varied due to a signal processing such as reception of the input signal, an original waveform can be restored to the greatest possible extent, by carrying out the foregoing method for making the pulse of the input signal close to the predetermined pulse width.

(3) Accordingly, it is preferable that the predetermined pulse width is standardized, irrespective of the pulse width of the input signal, taking into account a level of distortion in the pulse width, the distortion mainly attributed to the signal processing.

For example, if it is previously known that distortion which causes a pulse width to be lengthened is more likely to occur, the predetermined pulse width may be a pulse width that (i) reduces the lengthening of the pulse width and (ii) causes the pulse width to be close to that of the original waveform. In this case, all of the pulses are shortened to the predetermined pulse width through the waveform shaping. This enables a provision of a simple waveform shaping method which is excellent in reproducibility. This is advantageous in simplifying a configuration of a waveform shaping device for executing the waveform shaping method.

On the other hand, if it is previously known that distortion which causes a pulse width to be shortened is more likely to occur, the predetermined pulse width may be a pulse width that (i) reduces the shortening of the pulse width and (ii) causes the pulse width to be close to that of the original waveform. In this case, all of the pulses are lengthened to the predetermined pulse width through the waveform shaping. This enables a provision of a simple waveform shaping method which is excellent in reproducibility. This is advantageous in simplifying a configuration of a waveform shaping device for executing the waveform shaping method.

(4) The waveform shaping method may be so adapted that, when the input signal is a pulse signal generated through a signal processing carried out with respect to an original pulse signal on which the input signal is based, in the waveform shaping step, waveform shaping is carried out by shortening, by a predetermined value, a pulse width of the input signal, the pulse width being recognized from the sampling signal.

For example, in the method, the waveform shaping is carried out so that the pulse width is made closer to the predetermined pulse width by shortening the pulse width by the predetermined value. With this method, the original signal is more accurately obtained in a case where the pulse width of the input pulses are likely to be lengthened in a similar way, at the time of transmitting the input signal under the same conditions of communication distance and transmitting power.

(5) The waveform shaping method may be so adapted that, when the input signal is a pulse signal generated through a signal processing carried out with respect to an original pulse signal on which the input signal is based, in the waveform shaping step, waveform shaping is carried out by lengthening, by a predetermined value, a pulse width of the input signal, the pulse width being recognized from the sampling signal.

Incidentally, the pulse width of the input signal may be recognized as being shorter than the predetermined pulse width, when, for example, (i) noise is mixed into the input signal, (ii) a communication power is decreased, because a battery of a remote control is running out, or (iii) a communication distance is long. However, even in the above case, it is possible to accurately obtain the original signal, with the use of the foregoing method in which the waveform shaping is carried out so that the pulse width of the input signal is lengthened by the predetermined value.

(6) It is preferable that the predetermined value be standardized, irrespective of the pulse width of the input signal, and that the predetermined value be determined taking into account a level of distortion in a pulse width, the distortion mainly attributed to the signal processing.

The signal processing may vary depending on a purpose of carrying out the signal processing. Accordingly, it is possible to determine the level of the distortion by carrying out an actual measurement or the like, in accordance with the purpose of applying the waveform shaping method of the present invention. Then, based on the level of the distortion thus obtained, it is possible to determine the predetermined value that reduces the distortion, and restores the original waveform to the greatest possible extent.

By standardizing such a predetermined value, irrespective of the pulse width, the waveform shaping can be easily carried out.

(7) Further, the waveform shaping method of the present invention may be so adapted that, in the waveform shaping step, a pulse width recognized from the sampling signal is compared with a first reference value, and with a second reference value which is larger than the first reference value by a constant value; and when the input signal is a pulse signal generated through a signal processing carried out with respect to an original pulse signal on which the input signal is based, if the pulse width is equal to or larger than the second reference value, the pulse width is reduced by the constant value, irrespective of the pulse width.

With this method, it is possible to detect a distorted pulse whose pulse width is made longer than the second reference value. Further, since such a distorted pulse is shortened by a constant value irrespective of the pulse width, it is possible to make the pulse width close to the first reference value through a simple process. Thus, the lengthening of the pulse width due to distortion is restrained.

(8) Further, the waveform shaping method may be so adapted that, if the pulse width is larger than the first reference value but less than the second reference value, the pulse width is reduced, irrespective of the pulse width, so that the pulse width is made as close to the first reference value as possible.

With this method, it is possible to detect a distorted pulse whose pulse width is lengthened such that the pulse width does not exceed the second reference value. Further, by carrying out the same process, irrespective of the pulse width, with respect to such a distorted pulse width, it is possible to make the pulse width close to the first reference value, and restrain the lengthening of the pulse width attributed to distortion.

(9) Further, the waveform shaping method may be so adapted that the pulse width is not reduced if the pulse width is equal to or less than the first reference value.

With this method, it is possible to detect a pulse having a pulse width which is equal to or less than the first reference value, the pulse in which the distortion causing the lengthening of the pulse width does not occur. Further, in the method, the waveform shaping is not carried out with respect to such a pulse, so that the process is further simplified.

Note that the first reference value may be determined as is done with the case of determining the predetermined pulse width.

(10) Further, the waveform shaping method may be so adapted that, in the waveform shaping step, a pulse interval recognized from the sampling signal is compared with an interval reference value, and if the pulse interval is less than the interval reference value, the pulse interval is lengthened, irrespective of the pulse width, so that the pulse interval is made as close to the interval reference value as possible, the pulse interval being a width of a period having no pulse.

The lengthening of the pulse interval may be carried out before the pulse width is processed, or after the pulse width is processed.

The function and effect of lengthening the pulse interval are explained in a description regarding a method of carrying out waveform shaping, in which, when a no-pulse period is less than a setting value, a no-pulse period is used as a setting value.

Note that the interval reference value is determined, taking into account a level of distortion in a pulse width, the distortion mainly attributed to the signal processing. The function and effect of this is as mentioned before in the description regarding how to determine the predetermined value.

Further, the waveform shaping method may be so adapted that, if the input signal contains information related to the pulse interval of the input signal, the interval reference value is set based on the pulse interval read out from the information.

(11) Further, the waveform shaping method may be so adapted that the pulse interval is lengthened by shifting a position of a pulse adjacent to the pulse interval.

In this way, the pulse interval can be secured without changing the pulse width. Thus, it is possible to prevent such a problem that the lengthening of the pulse interval makes the pulse width short.

Further, as in the pulse width, it is possible that, if the input signal contains information related to the pulse width of the input signal, the information is read out, and the first reference value is determined based on the information.

Further, as is the case with the predetermined value, the waveform shaping method may be so adapted that the constant value is determined based on (i) a lower limit value of a possible pulse width range of the input signal, and (ii) an inverse number of a sampling clock frequency, and the constant value is set less than the lower limit value. Further, the waveform shaping method may be so adapted that if the input signal contains information related to the pulse width of the input signal, the constant value is set smaller than the pulse width read out from the information.

(12) Further, a waveform shaping device of the present invention may includes: sampling means; and waveform shaping means, wherein the sampling means samples a pulse signal at a sampling period shorter than a minimum pulse width and a minimum pulse interval in the pulse signal, so as to generate a sampling signal which is a discrete symbol string for replacing the pulse signal, the pulse signal being generated by carrying out a signal processing with respect to an original pulse signal, the waveform shaping means compares a first symbol count with a first reference value and a second reference value which is a constant value larger than the first reference value, where (i) the first symbol count is a number of symbols in a first symbol string having been replaced for a pulse-existing period, and (ii) a second symbol count is a number of symbols in a second symbol string having been replaced for a no-pulse period adjacent to the pulse-existing period, and if the first symbol count is equal to or more than the second reference value, the waveform shaping means partially replaces the first symbol string with the second symbol string by the constant value, irrespective of a pulse width of the pulse signal generated through the signal processing, so as to shorten the pulse-existing period.

The pulse signal is generated through the signal processing carried out with respect to the original signal. This signal process may cause a difference between the waveform of the pulse signal and the waveform of the original pulse signal, by lengthening or shortening the pulse width, or by shifting a position of the pulse. In order to eliminate the difference, and to cause the waveform of the pulse signal to be close to the waveform of the original pulse signal, the waveform shaping device of the present invention includes the sampling means and the waveform shaping means.

Further, the sampling period is set shorter than the minimum pulse interval or the minimum pulse width. The pulse interval is a period of time in which no pulse is occurring. As such, through the sampling, it is possible to replace, without omission, the waveform of the pulse signal with the discrete symbol string. That is, the pulse-existing period and the no-pulse period are replaced with symbol string whose respective data values are different. In other words, the pulse-existing period and the no-pulse region are respectively replaced with the first symbol and the second symbol, where the second symbol string has data that is different from that of the first symbol. The symbol string may be binary data containing values of “1” and “0”, or multi-valued data containing three values or more.

The number of symbols in each of the symbol string is proportional to a length of the pulse width or the pulse interval, in terms of time.

Note that a method of determining the sampling period is not the essence of the present invention. If it is previously known what type of signal processing is carried out with respect to what original pulse signal, the minimum pulse width can be previously found by carrying out an actual measurement or the like. Accordingly, the sampling period may be determined based on the minimum pulse width found. Further, when the present invention is applied to a case where the types of original signal and signal processing varies, a possibly-predicted minimum pulse width may be used as a reference pulse width for previously determining the sampling period that can avoid a possible error, the sampling period being shorter than the reference pulse. Further, it is possible to provide a waveform shaping device with means for finding the minimum pulse width by analyzing the pulse width, and determine the sampling period based on the minimum pulse width thus found out. The sampling frequency can be determined in any of these cases.

Next, if the number of the first symbols in the first symbol string corresponding to the pulse is recognized by the waveform shaping means as being more than the second reference value, the waveform shaping means replaces an amount, corresponding to the constant value, of the first symbol string with the second symbol string. This shortens the pulse width by the constant value, and the following pulse interval is lengthened by the constant value.

This process is uniformly carried out as long as the pulse width is equal to or longer than the second reference value. Accordingly, all of the pulse widths are made close to the first reference value, which is more preferable, by carrying out the simple method in which the severely distorted pulses whose pulse width exceeds the second reference value are uniformly shortened by the constant value, irrespective of the actual pulse width.

For example, the closer the first reference value is to the original pulse width of the pulse signal, more likely the waveform of the pulse signal is to be made close to that of the original signal.

As described, it is possible to simplify a configuration of a waveform shaping device by so arranging the waveform shaping means that waveform shaping is carried out irrespective of the pulse width, as long as the pulse width exceeds the second reference value.

Note that methods for determining the first reference value and the constant value are described in detail in the description regarding the invention of the waveform shaping method.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating a waveform shaping device of embodiments in accordance with the present invention.

FIG. 2(a) to FIG. 2(d) are timing charts illustrating an example of a waveform shaping method of embodiments in accordance with the present invention.

FIG. 3(a) to FIG. 3(c) are timing charts illustrating another example of the waveform shaping method of embodiments in accordance with the present invention.

FIG. 4 is a timing chart illustrating a typical pulse width and a typical pulse interval, in an infrared remote control communication.

FIG. 5 is another timing chart illustrating a specification of a range of the pulse width and the pulse interval, in an infrared remote control communication.

FIG. 6 is a waveform diagram illustrating a typical remote control signal.

FIG. 7(a) to FIG. 7(e) are timing charts illustrating yet another example of the waveform shaping method of embodiments in accordance with the present invention.

FIG. 8 is a timing chart illustrating a problem to be solved by the waveform shaping method of the present invention.

FIG. 9 is a block diagram illustrating a configuration of a main part of the waveform shaping device in accordance with the present invention.

FIG. 10(a) and FIG. 10(b) are timing charts illustrating still another example of the waveform shaping method of the embodiments in accordance with the present invention, the waveform shaping method for solving the foregoing problem.

FIG. 11 is a flowchart illustrating the waveform shaping method of an embodiment in accordance with the present invention.

FIG. 12 is a flow chart illustrating an example for explaining in detail a waveform shaping process S103 shown in FIG. 11.

FIG. 13 is an example of data string yet to be subjected to the waveform shaping process of FIG. 12, and an example of data having been subjected to the waveform shaping process of FIG. 12.

FIGS. 14(a) to 14(c) are timing charts respectively illustrating examples of modulation methods involving a remote control signal.

FIG. 15(a) and FIG. 15(b) are timing charts illustrating a decoding process carried out when a waveform distortion occurs in the modulation method illustrated in FIG. 14(a).

FIG. 16(a) and FIG. 16 (b) are timing charts illustrating a decoding process carried out when a waveform distortion occurs in the modulation method illustrated in FIG. 14(b).

FIG. 17(a) and FIG. 17(b) are timing charts illustrating a decoding process carried out when a waveform distortion occurs in the modulation method illustrated in FIG. 14(c).

FIG. 18(a) to FIG. 18(c) show a case of using the modulation method of FIG. 14(c), and illustrate, in the form of timing charts, results which are respectively obtained from S1504 and S1506 being sequentially carried out with respect to a trailing part of a pulse, S1504 and S1506 being processes of the waveform shaping process illustrated in FIG. 12.

FIG. 19(a) to FIG. 19(c) show a case of using the modulation method of FIG. 14(c), and illustrate, in the form of timing charts, results which are respectively obtained from S1504 and S1506 being sequentially carried out with respect to a trailing part of a pulse, S1506 and S1504 being processes of the waveform shaping process illustrated in FIG. 12.

FIG. 20(a) to FIG. 20(c) show a case of using the modulation method of FIG. 14(c), and illustrate, in the form of timing charts, results which are respectively obtained from S1504 and S1506 being sequentially carried out with respect to a leading part of a pulse, S1504 and S1506 being processes of the waveform shaping process illustrated in FIG. 12.

FIG. 21(a) to FIG. 21(c) show a case of using the modulation method of FIG. 14(c), and illustrate, in the form of timing charts, results which are respectively obtained from S1504 and S1506 being sequentially carried out with respect to a leading part of a pulse, S1506 and S1504 being processes of the waveform shaping process illustrated in FIG. 12.

FIG. 22 is a block diagram-illustrating an example of a conventional signal transmission system.

FIG. 23 is a block diagram illustrating a main part of the conventional signal transmission system.

FIG. 24(a) to FIG. 24(h) are timing charts each of which illustrating how a signal is processed in the conventional signal transmission system.

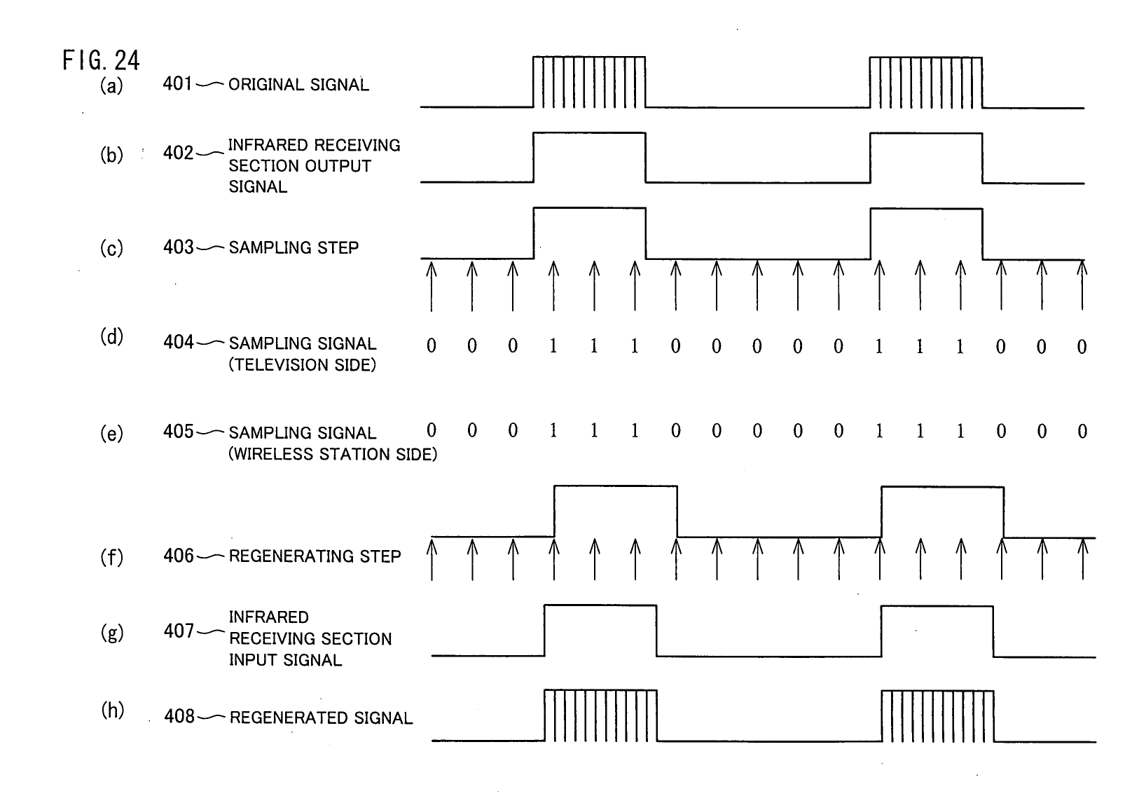

FIG. 25 is a block diagram and a waveform diagram illustrating how the signal is deteriorated in the conventional signal transmission system.

### BEST MODE FOR CARRYING OUT THE INVENTION

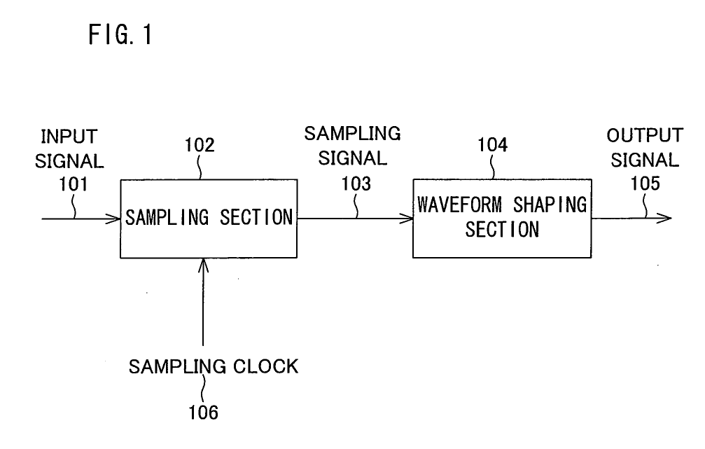

The following deals with embodiments of the present invention, with reference to the figures. FIG. 1 illustrates a waveform shaping method of the present embodiment. Note that the same symbols are given to the members that have the same functions as those described in Background Art, and the descriptions of those members are omitted here as a matter of convenience.

### Embodiment 1

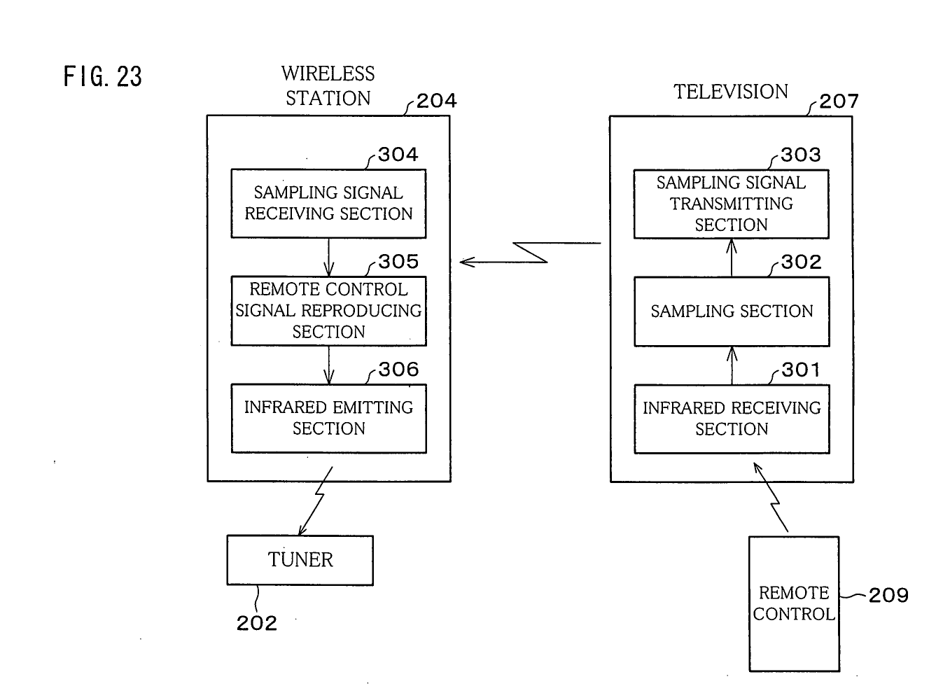

A waveform shaping method and a waveform shaping device of the present invention realize a structure for properly reproducing, on a wireless station side, a digital signal such as a remote-control signal whose information is subjected to a wireless transmission. Such a structure is realized by an arrangement in which: (i) a conventional sampling section 302 of a television 207 shown in FIG. 23 is improved so that the sampling section 302 corrects a distortion which has been generated by a conventional infrared receiving section 301; and (ii) the waveform shaping method and the waveform shaping device are made to be all-applicable method and device which are not influenced by a characteristic of the infrared receiving section 301.

In the present invention, the sampling section 302 is replaced with an improved sampling section (sampling means) 102 and a waveform shaping section (waveform shaping means) 104 illustrated, as constituting a waveform shaping device of the present invention, in FIG. 1. Further, the present invention is carried out by the following respective steps of a waveform shaping method in accordance with the present invention.

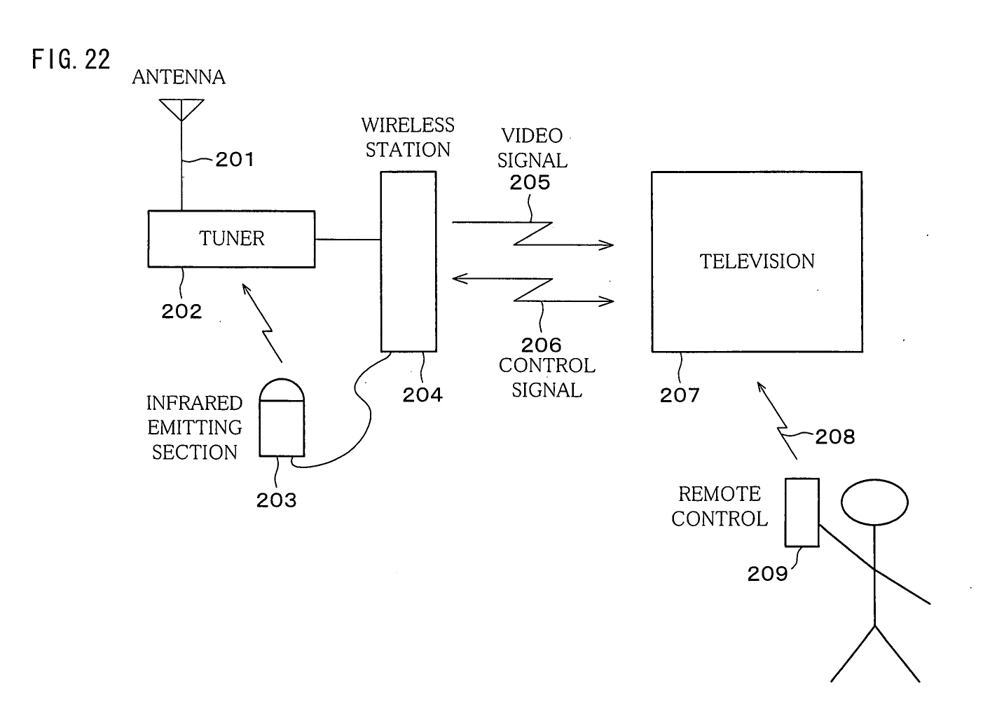

Note that an antenna 201 and a tuner 202 illustrated in FIG. 22 may be substituted with a device for recording/reproducing a video signal and/or various kinds of data; e.g., a Video-Tape recording/reproducing device, an Optical-Disc recording/reproducing device, a Magnetic disc recording/reproducing device, or the like.

Digital communication systems of various kinds are provided with the infrared receiving section 301 and the sampling section 302 described in “Background-Art”. The infrared receiving section 301 and the sampling section 302 may generally be mounted as software and/or a device, each of which are different on a product-to-product basis, or on a maker-to-maker basis.

The present invention is for enabling restoration of an original pulse shape to a greatest possible extent, by carrying out a waveform shaping by subsequent hardware or subsequent software which receives, as an input signal, an output signal of the infrared receiving section. This is irrespective of the makers (standards) of the infrared receiving section and the remote control for transmitting a remote-control signal to the infrared receiving section. As such, an electronic device of the present invention includes: a receiving device, similar to the infrared receiving section for receiving and processing the remote-control signal, for generating the input signal relating to the present invention; and a waveform shaping device (described later) of the present invention.

Note that a remote-control-signal receiving section including the infrared receiving section, the waveform shaping device, and a sampling signal transmitting section may be integral with a main body of an electronic device such as a television. Alternatively, the remote-control-signal receiving section may be externally provided as an option.

Concrete examples of the electronic device are: (i) a home-use appliance, such as a television, an air conditioner, a stereo set, a microwave oven, a refrigerator, and a laundry machine, which control a target operation; or (ii) a control-use communication device such as Bluetooth (registered trademark).

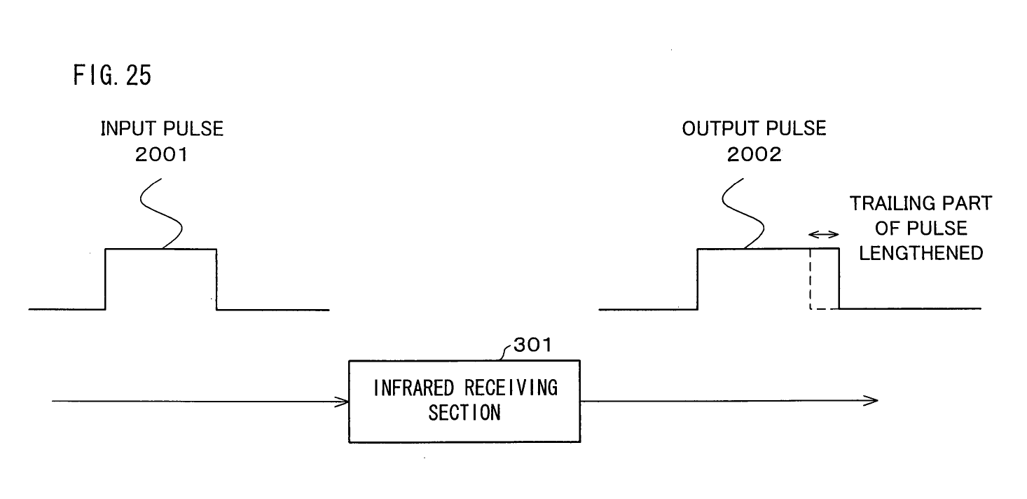

An input signal 101 is a signal in a wireless/wired digital communication. The input signal 101 has a waveform which is obtained by distorting an original pulse shape. For example, as illustrated in FIG. 25, the input signal 101 is kind of an output pulse 2002 obtained by removing a carrier wave through a detection process or the like, the output pulse 2002 being outputted from the infrared receiving section (receiving device) 301. In the infrared receiving section 301, a signal processing is carried out with respect to a received infrared signal. In the signal processing, a photoelectric transfer is carried out with respect to the received infrared signal. The received infrared signal is then demodulated. At this point, the distortion of the input signal 101 varies depending on a signal processing characteristic, particularly on a photoelectric transfer characteristic.

It is needless to say that the input signal 101 is not limited to the output signal from the infrared receiving section 301. The input signal 101 may be various signals having the similar properties. For example, the input signal 101 may be a signal obtained after receiving a wireless signal in the form of an electric wave from a wireless transmitter instead of from the remote control 209 of FIG. 23. Here, the distortion is a difference between (i) a pulse containing in an original waveform of an original pulse signal, and (ii) a pulse which has been subjected to a signal processing. The pulse of the original pulse signal is used for transmitting information. The information is transmitted by: (i) using any one of a pulse width, a pulse interval, a pulse position, or a pulse amplitude; or (ii) using a selective combination of these factors. As is already described with reference to FIG. 25, a pulse width in general tends to increase in the infrared receiving section.

Further, “original waveform” is supposed to be: (I) a waveform of the original pulse signal which has not yet been supplied to the infrared receiving section 301; (II) a waveform at the time when a signal is outputted from the remote control 209; or (III) a waveform of a signal which is generated in a stage preceding an infrared emitting section in the remote control 209. The present embodiment deals with a case of the infrared communication in which a sub carrier wave is superimposed (multiplied) to the original pulse signal during a communication. The “original waveform” therefore is a waveform of the original pulse signal which has not yet been subjected to the superposition of the sub carrier wave by the remote control. Alternatively, when supposing a state in which the sub carrier wave is cut out of the remote-control signal to be supplied to the infrared receiving section 301 (no sub carrier wave is superimposed), the “original waveform” may be a waveform of such a state.

The sampling section 102 samples the input signal 101 in sync with a sampling clock 106. Sampling is to convert a signal which is continuous in terms of time into a discrete signal (symbol string) in sync with a sampling clock. This is referred to as sampling. For example, a method for the sampling can be PCM (pulse symbol modulation) or the like for use in a CD (Compact Disc). The input signal 101 to be inputted to the sampling section 102 is an output signal from the infrared receiving section or the like. In general, the input signal 101 is a continuous signal having pulses such as a square wave or a sine wave with high and low levels of electric potential.

The sampling section 102 samples the input signal 101, so that a sampling signal 103 is generated. The sampling section 102 may be realized in terms of either hardware or software. It is needless to say that the waveform shaping section 104 may be also be realized likewise in terms of either hardware or software.

In the sampling section 102, the continuous physical signal having the high and low levels of electric potential is thus converted into discrete logical signals. For example, the high and low levels of the electric potential are respectively converted into the logical signals representing “1” or “0”, “High” or “Low”, or “a” or “b”. In this way, the sampling signal 103 is obtained.

In the present embodiment, the electric potential is expressed in two levels (binary). Alternatively, the electric potential may be expressed in multiple levels as in the case of a multiple-value. ASK (Amplitude Shift Keying) modulation or the like. In that case, a sampling signal obtained by sampling an input signal at a certain timing is expressed in multiple values. For example, the sampling signal may have a multiple-value such as (A) “11,” “10”, “01”, or “00”; (B) “a”, “b”, “c”, or “d”; or (C) “0”, “1”, “2”, or “3”.

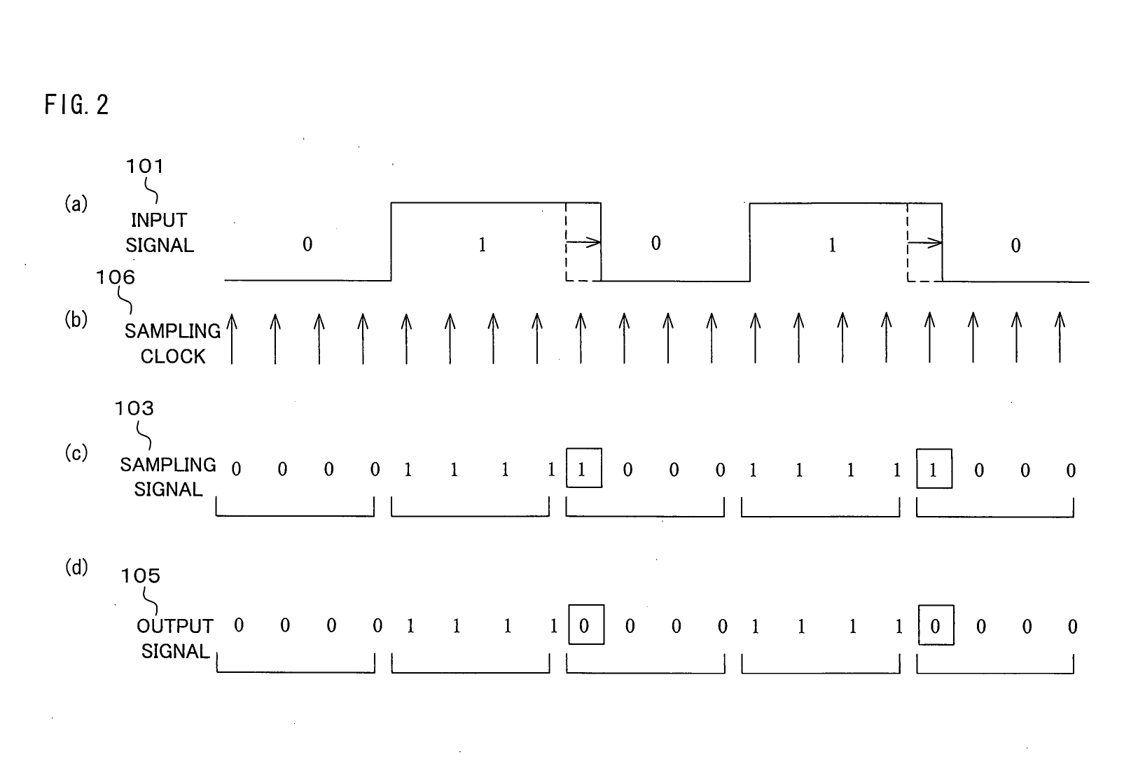

Further, since the sampling signal 103 is a logical signal, it is not necessary that the high electric potential be fixed to “1” and that the low electric potential be fixed to “0”. It is possible to express the high electric potential as “0”, and the low electric potential as “1”. However, for convenience of explanation, in the present embodiment, the original waveform of a signal is expressed in two values of the high electric potential and the low electric potential. The following explanation is provided assuming that the high level electric potential is expressed as “1”, and that the low level electric potential is expressed as “0”. As such, the sampling signal 103 of the present embodiment is expressed in the form of a symbol string which is a combination of “1” and “0” (See FIG. 2(c)).

Incidentally, in general, the infrared receiving section 301 outputs inverted signals; i.e., the low electric potential is outputted when there is a pulse, and the high electric potential is outputted when there is no pulse. This is generally called “Low Active”. For convenience of explanation, the present embodiment deals with a case of “High Active”. That is, when the pulse starts, the electric potential transits from the Low level to the High level. On the other hand, when the pulse ends, the electric potential transits from the High level to the Low level. In other words, it is assumed that a rising edge occurs at the beginning of the pulse, and the falling edge occurs at the end of the pulse. In a case where the infrared receiving section 301 operates in accordance with “Low Active”, the description of the present embodiment as to the levels needs to be inverted.

Although the sampling signal 103 merely indicates a logical value of “1” or “0” when giving an eye to a sampled result at a certain timing. However, it is possible to clarify a relationship between the input signal 101 and the sampling signal 103, by taking the sampling signal 103 as data of a set of bit string (symbol string) which is obtained as a result of sampling the input signal 101, and by observing a plurality of such data.

For example, data “01” of the sampling signal 103 means that a rising edge has occurred in a pulse of the input signal 101. On the other hand, data “10” of the sampling signal 103 means that a falling edge has occurred in a pulse of the input signal 101. It is possible to recognize that a pulse width of the pulse existing in each sampling signal 103 is from the rising edge to the falling edge. More specifically, by regarding each sampling signal 103 as the data set of bit string (symbol string), it is possible to recognize, based on an alignment of the bits (symbols), pulse-information included in the sampling signal 103. For example, the pulse-information may be a position of the pulse (e.g., a transition from “0” to “1”), a width of the pulse (e.g., the number of consecutive bits or the number of consecutive symbols, such as the number of consecutive repetitions of “1”), or a positional relationship between pulses.

Further, the information thus recognized is basically identical to the information of the input signal 101. However, in general, there is a difference between the input signal 101 and the sampling 103. This is attributed to a relationship between (a) a pulse width and pulse interval of the input signal 101, and (b) a speed (sampling cycle) of the sampling clock 106. This difference can be reduced by increasing the speed of the sampling clock 106.

Incidentally, the sampling signal 103 may include sampled results in which “0” is sampled as “1” or “1” is sampled as “0” due to noise. Therefore, a measure for avoiding a false recognition due to the noise may be devised. For example, the false recognition can be prevented by determining a range of the pulse width, and judging a pulse to be noise or judging that noise is contained therein, when the pulse has a pulse width which does not fall within the range. Further, the pulse width may be shorter or longer than an original pulse width, depending on an output condition of the infrared receiving section 301. Accordingly, a range of the pulse width may be set appropriately in accordance with an actual condition.

The waveform shaping is carried out on the sampling signal 103, through various processes (described later), in the pulse-reshaping section 104 which is the most important section in the present invention. Then, an output signal 105 which has been subjected to the waveform shaping is outputted from the pulse-reshaping section 104. The waveform shaping is for processing the width, the position and/or the positional relationship of the pulses which are recognized from the bit string data (i.e., the sampling signal 103) obtained from the input signal 101 including a distortion.

More specifically, for example, in the waveform shaping, a processing in which “110”, part of the bit string data of the sampling signal 103, is converted into “100”. Here, a bit-string-correction (symbol string-correction) is carried out so that the second “1” in “110” is inverted to “0”. The correction allows the position of the falling edge to come earlier. That is, the correction allows a processing in which the pulse widths are reduced.

Thus, it is possible to process the information about the pulse contained in each sampling signal 103, which information can be recognized by taking each sampling signal 103 as the bit string data. By processing part of the bit string data, it is possible to restore (i) the rising/falling edge, (ii) the width, (iii) the position of the pulse in the sampling signal, and (iv) the positional relationship of the pulses, to those of the original waveform.

FIG. 2(a) to FIG. 2(d) illustrate waveforms and signals of the respective sections. Generally, as illustrated in FIG. 2(a), in the signal (the input signal 101 to be inputted to the sampling section 102) outputted from the infrared receiving section 301, an original trailing end (falling edge portion) of a pulse illustrated by the broken line tends to be distorted in such a manner that the pulse is stretched as illustrated by the solid line in FIG. 2(a). The input signal 101 is sampled in sync with the sampling clock 106.

As illustrated in FIG. 2(b), a speed of the sampling clock 106 is set four times faster than a data speed indicated by the pulse width of the input signal 101. However, it is possible to carry out the sampling at various speeds, provided that the sampling speed is faster (higher in speed) than the speed of the input signal 101. Note that the description reading “a speed of the sampling clock 106 is set four times faster than a data speed” means that (I) a sampling cycle is ¼ of a pulse width (standard value) in a case of later described pulse width fixing method, and (II) a sampling cycle is ¼ of a minimum pulse (standard value) in a case of a pulse interval fixing method.

A reason why the speed of the sampling clock 106 needs to be “faster than the data speed” of the input signal 101 is that a sampling theorem needs to be satisfied, in order to sample the signal waveform in the input signal 101 without omission and to reproduce (restore) the original signal without fault.

As a result of sampling the input signal 101 in sync with the sampling clock 106, the sampling signal 103 as illustrated in FIG. 2(c) is generated.

As is clear from the figure, in the obtained bit string data of the sampling signal 103, there is a bit whose value is “1” even though the value should be “0”. This is because the input signal 101, which has been transmitted, has a pulse width stretched wider than the original pulse width of the input signal 101 which has not been subjected to being transmitted.

Accordingly, in the waveform shaping section 104, the following waveform shaping is carried out: the bit string data of the inputted sampling signal 103 is partially inverted, so that the bit, of the sampling signal 103, which should be “0” is corrected from “1” to “0”. Then, the output signal 105 which has been subjected to the waveform shaping is outputted from the waveform shaping section 104. It is possible to rephrase this process as a process in which (i) the pulse width is converted into the bit string (symbol string) of the logic value “1”, and (ii) the number of the bits (the number of the symbols) in this bit string is reduced. It is also possible to rephrase the process as a process in which the symbol string converted in accordance with the pulse width is partially replaced with a symbol string which corresponds to the pulse interval. Note that the later description suggests various waveform shaping algorithms (waveform shaping processes) other than the above waveform shaping algorithm.

Next, the following describes in detail a configuration and an operation of the waveform shaping device that carries out waveform shaping by partially inverting the bit string data. A basic idea of the waveform shaping process of the present invention is schematically that the number of bits corresponding to a pulse width or a pulse interval is processed in line with a predetermined standard, irrespective of the pulse width of the pulse signal outputted after the infrared receiving section 301 or the like processed the original signal.

A There are various methods for setting the predetermined standard. As such, as an example, a detailed explanation is provided later for various methods for shortening a pulse width.

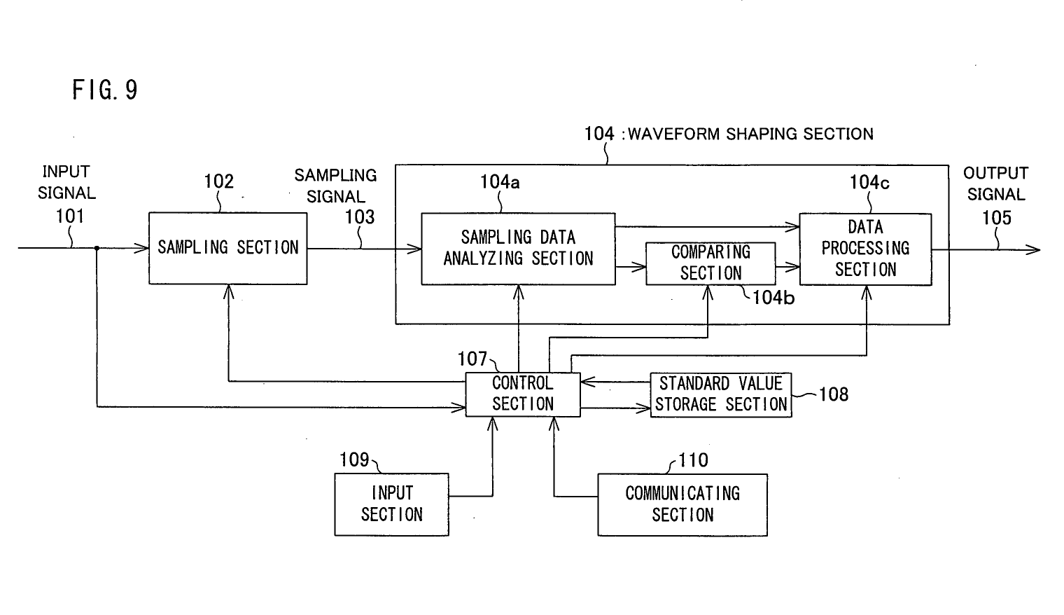

FIG. 9 illustrates a further detailed configuration of the waveform shaping device (See FIG. 1) for realizing the waveform shaping method of the present invention. The waveform shaping device of the present invention illustrated in FIG. 9 corresponds to the sampling section 302 of FIG. 23, and the pulse-reshaping device is therefore a substitute for the sampling section 302.

The waveform shaping device of the present invention includes: the sampling section 102 (sampling means); the pulse-reshaping section 104 constituted by (a) a sampling data analyzing section 104a, (b) a comparing section 104b, and (c) a data processing section 104c; the sampling section 102 and the pulse-reshaping section 104 have already been described with reference to FIG. 1. The waveform shaping device of the present invention further includes a control section 107, a reference value storage section 108, an input section 109, and a communication section 110. Note that the waveform shaping section 104 and the control section 107 correspond to the waveform shaping means of the present invention.

The sampling data analyzing section 104a analyzes an alignment of the bits (symbols) constituting the sampling signal 103 (i.e., sampling data) supplied from the sampling section 102, upon reception of an instruction given by the control section 107. Then the sampling data analyzing section 104a carries out operations of, for example, (1) detecting the rising edge or the falling edge of the pulse in the inputted signal 101, based on transitions in the bits; (2) detecting the number of bits (number of symbols) which corresponds to the pulse width; and/or (3) detecting the number of bits which corresponds to the pulse interval (width of an interval having no pulse). Note that the sampling data analyzing section 104a outputs a result of the analysis to the comparing section 104b. Further, the sampling data analyzing section 104a outputs, to the data processing section 104c, data of the sampling signal 103 which has been subjected to the analysis.

For example, the comparing section 104b obtains the number of bits corresponding to the pulse width, upon reception of an instruction from the control section 107. Then the comparing section 104b compares the number of bits with a reference value supplied from the control section 107.

Upon reception of an instruction from the control section 107, the data processing section 104c processes the data inputted from the sampling data analyzing section 104a in accordance with the result of the comparison in the comparing section 104b. For example, the data processing section 104c increases or decreases the number of the bits corresponding to the pulse width so that the number of bits becomes closer to the reference value. Alternatively, the data processing section 104c increases or decreases the number of bits corresponding to the pulse width by using a constant value supplied from the control section 107.

The data process carried out by the data processing section 104c is not limited to a process which uses the result from the comparing section 104b. There may be a process in which the comparison in the comparing section 104b is not carried out with respect to the output from the sampling data analyzing section 104a. In this case, the output from the sampling data analyzing section 104a merely passes through the comparing section 104b and enters the data processing section 104c. Such a case is, for example, a case of carrying out such a waveform shaping process that the data processing section 104c reduces the pulse width by a predetermined amount, irrespective of the pulse recognized by the sampling data analyzing section 104a; i.e., without the comparison of the pulse width with the reference value.

In this way, the data which has been thus processed by the data processing section 104c is outputted as the output signal 105. Note that the comparing section 104b and the data processing section 104c carry out various operations. The details of these operations are described later.

The control section 107 generates a sampling clock 106 illustrated in FIG. 1, and supplies the sampling clock 106 to the sampling section 102. Further, the control section 107 organically controls the operations of the respective sections and a signal input/output timing.

The reference value storage section 108 stores and retains therein the reference value, the constant value, or the like in a rewritable or fixed manner.

The input section 109 is for accepting user's instructions via key operations and providing them to the control section 107. The communicating section 110 also accepts user's wired/wireless instructions from other computer or an input device, and provides them to the control section 107. The control section 107 analyzes the user's instructions. Then, the control section 107 controls the operation of each section in accordance with the user's instructions, or causes the reference value storage section 108 to store, for example, user's set values in relation to the waveform shaping. For example, the user's set values include the reference value and/or the constant value.

Note that the sampling data analyzing section 104a, the comparing section 104b, and the data processing section 104c can be a module realized by using hardware or software. In the case of using software, the sections 104a through 104c and the control section 107 are constituted by a CPU (Central Processing Unit) and programs in which processes of the respective sections are described.

Further, the reference value storage section 108 can be constituted by a storage device such as an ROM (Read Only Memory), an RAM (Random Access Memory), or a Flash memory. The input section 109 can be constituted by an interface and an input device such as a keyboard, a mouse, or a touch panel. The communicating section 110 can be constituted by a modem and a communication interface.

Embodiment 1 describes a fundamental of the waveform shaping by increasing/decreasing the bit number, on the basis of the above described configuration.

The waveform shaping can be carried out by inverting a bit value at a position of the rising/falling edge so that the number of the bits representing the pulse width is increased or decreased. The position of the rising/falling edge is found from the bit string data signal. For example, when the sampling data analyzing section 104a monitors the bit string, and finds a position where the value transits from “1” to “0”, the sampling data analyzing section 104a carries out an inversion to “0” from “1” immediately before the value “0”. In this way, the waveform shaping is carried out, i.e., the pulse width can be reduced.

When the values “100” are processed to “110”, the falling edge is stretched backwards. In this way, it is also possible to carry out a processing for broadening the pulse width. The rising edge can be also processed likewise, and various waveform shaping can be carried out. Further, the waveform shaping does not necessarily have: to be carried out with respect to only one bit. It is possible that the data processing section 104c inverts two consecutive bits of “1” to two consecutive bits of “0”. For example, when “110” is found, “110” is processed to “000”.

In general, an input signal often contains a noise (e.g., “11110111000”). Mere monitoring of a group of several bits may cause the waveform shaping to be carried out with respect to the noise. In this case, the waveform shaping may be carried out by the data processing section 104c, when the sampling data analyzing section 104a apparently acknowledges a falling edge based on the fact that a condition is met. For example, such a condition is met when, after further monitoring another several bits like “11111000”, the number of consecutive “1”s and “0”s, in the vicinity of the time of changing from “1” (first symbol) to “0” (second symbol), exceeds a reference value read out of the reference value storage section 108.

On the other hand, in a case of a bit string “11110111000”, the sampling data analyzing section 104a acknowledges that a falling edge has occurred between the third and fourth bit from the last bit, and that a bit string converted from the pulse width is “1111011”. Then, the waveform is shaped by the data processing section 104c so that the number of the same symbols (i.e., the number of “1”s) in the bit string is reduced. The reduction gives rise to “11110110000”.

Alternatively, the sampling data analyzing section 104a may acknowledge that the fifth bit “0” is a noise being mixed in. In this case, the waveform shaping may be carried out by inverting the fifth bit “0” into “1”. Thus, the bit string converted from the pulse width has the identical values of “1”. This improves a quality of a signal.

As described, a pulse waveform can be shaped by acknowledging a falling edge or a rising edge of the pulse signal based on the number of consecutive first and second symbols of the sampling signal in the vicinity of the time of changing from the first symbol to the second symbol, and by increasing or decreasing, by a predetermined amount, the number of the identical symbols in the symbol string converted from the pulse width, irrespective of characteristics of signal processing which is carried out with respect to an original signal; i.e., irrespective of the pulse width of the inputted pulse signal.

In other words, an output signal (discrete data) is generated by correcting the alignment of the symbol string in the data processing section 104c. By converting the output signal into a continuous pulse signal, the pulse signal has a waveform which is close to that of the original pulse signal.

Further, since the waveform shaping of the present invention can be carried out by processing the alignment of the symbol string in compliance with a predetermined rule, it is possible to easily realize the waveform shaping method of the present invention by using software. This brings about an advantage in enabling of an upgrading, without modification of hardware.

### Embodiment 2

In general, a headmost portion of a pulse in a signal (an input signal 101 to be inputted to a sampling section 102) outputted from an infrared receiving section 301 is properly outputted. However, a portion on a rear side of the pulse tends to be lengthened. A waveform shaping may be carried out with respect to both rising and falling edges. However, in consideration of the characteristic, it is possible to be close to the original waveform, while an occurrence of jittering is restrained, by carrying out the waveform shaping with respect to the falling edge (See FIG. 2(a) to FIG. 2(d)), and not to the rising edge.

### Embodiment 3

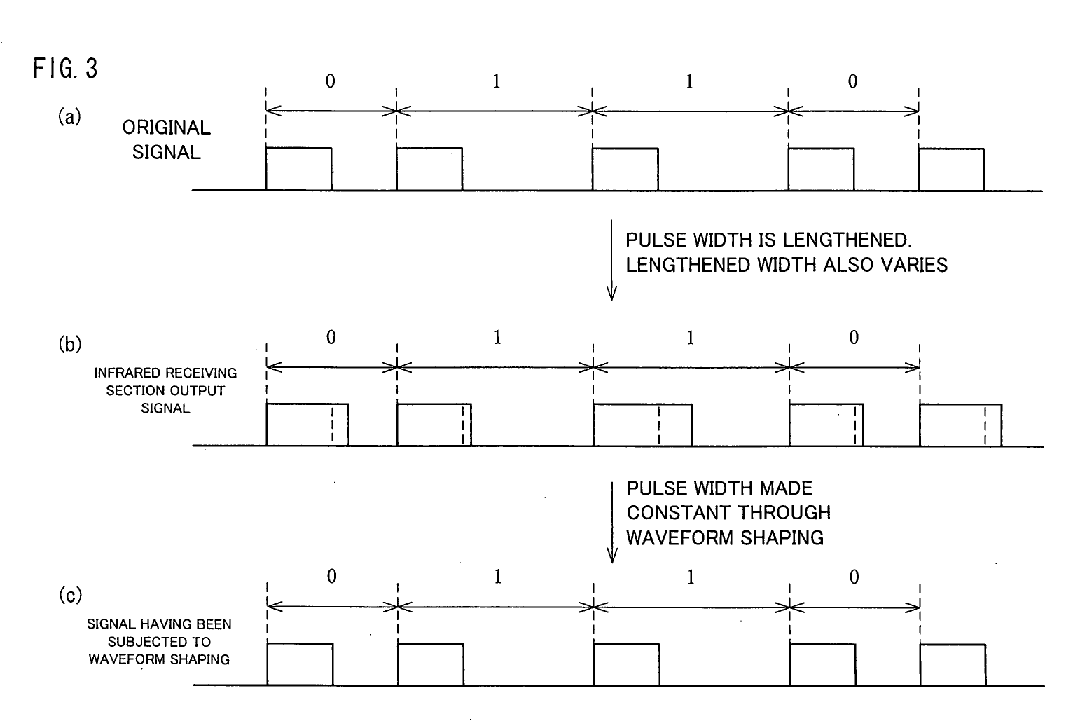

In general, information is often transmitted by making a pulse width fixed in a remote control signal, as illustrated in FIG. 3(a), while varying a pulse interval. For example, a first interval is determined as data “0”, and a second interval which is longer than the first interval is determined as data “1”. When the remote-control signal is outputted from the infrared receiving section 301, the pulse width may be lengthened by various amounts, as illustrated in FIG. 3(b).

In this case, as illustrated in FIG. 3(c), a waveform of the pulse may be made close to an original pulse waveform, by carrying out the waveform shaping with respect to any pulse containing a distortion so that the pulse widths of all the pulses are made to be close to predetermined pulse widths.

Incidentally, at the time of carrying out a communication, the pulse width is previously determined in many cases. For example, according to remote-control symbols of a company A (i) a pulse width is 250 μs (micro second), (ii) a pulse interval of the data “0”, is 1 ms (millisecond), and (iii) a pulse interval of the data “1” is 2 ms. Thus, there are cases where the predetermined pulse width is known at the time of starting the communication. It is possible to use the known pulse width as the predetermined pulse width. By using this predetermined pulse width, it is possible to adopt a simple method, such as a method in which the pulse width of all of the pulses are so controlled as to coincide with a standard value; i.e., the predetermined pulse width, when carrying out only a waveform shaping specialized for the remote-control symbols of the company A.

In this case, for example, a reference bit number indicative of a predetermined pulse width (the standard value) is stored in a reference value storage section 108. A comparing section 104b calculates and finds a range of the number of bits to be increased or decreased, by successively comparing (a) bit numbers respectively corresponding to the pulse widths found by the sampling data analyzing section 104a with (b) the reference bit number read out, by the control section 107, from the reference value storage section 108. A result of the calculation is passed on to the data processing section 104c, so that the data processing section 104c can carry out a process for coinciding the bit number of each pulse with the reference bit number.

This method however does not realize a waveform shaping which deals with every specification of the remote-control signal and the infrared receiving section 301. On the other hand, the present invention is for providing a waveform shaping method and a waveform shaping device, each of which being applicable to not only a waveform shaping specialized for one kind of specification, but also any kinds of specifications, as described later

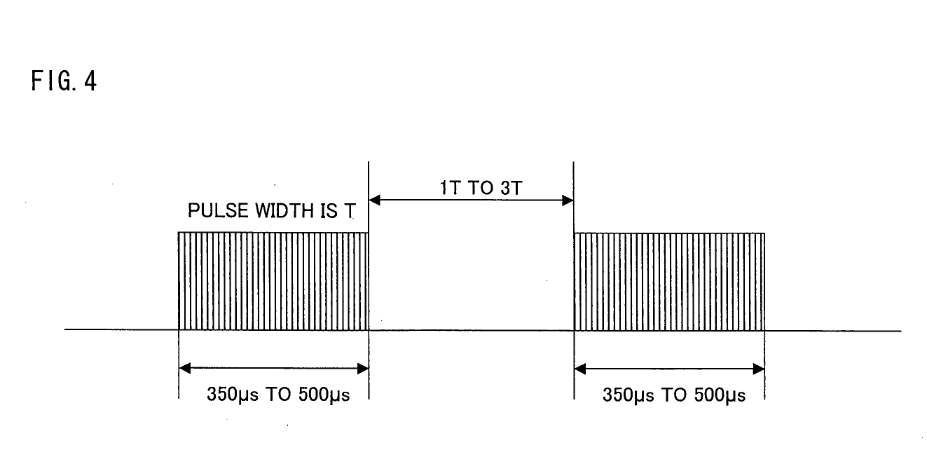

Here, a meaning of “predetermined” is described below. Amongst infrared remote controls in general, there are ones which adopt a pulse width and a pulse recommended by the Association for Electric Home Appliances (AEHA). According to the recommendation, the pulse width is 350 μs to 500 μs, and a pulse interval is 1 to 3 times of the pulse width (See FIG. 4).

Meanwhile, amongst the infrared remote controls actually being produced by various home appliance makers, some of them are in compliance with the recommendation of AEHA, while some adopt original standards of the respective makers. Nevertheless, the pulse width falls within a range from approximately 250 μs to 600 μs, and the pulse interval falls within a range from approximately 1 to 3 times of the pulse width. Therefore, the pulse width and the pulse interval are used which are close to those recommended by the AEHA.

Further, the following non-patent document may be referred to which deals with a distortion, similar to the above distortion, occurring upon input of an infrared signal to an infrared receiving section. For example, according to http://www.sharp.co.jp/products/device/ct1g/jsite23/tab le/123.html (as of Jun. 10, 2003), a specification of an infrared receiving unit of GPIUM27RK series produced by SHARP Corp. is such that a pulse width is 600 μs to 1200 μs, and a pulse interval is 400 μs to 1000 μs, when a signal with a pulse width of 600 μs and a pulse interval of 1000 μs is supplied.

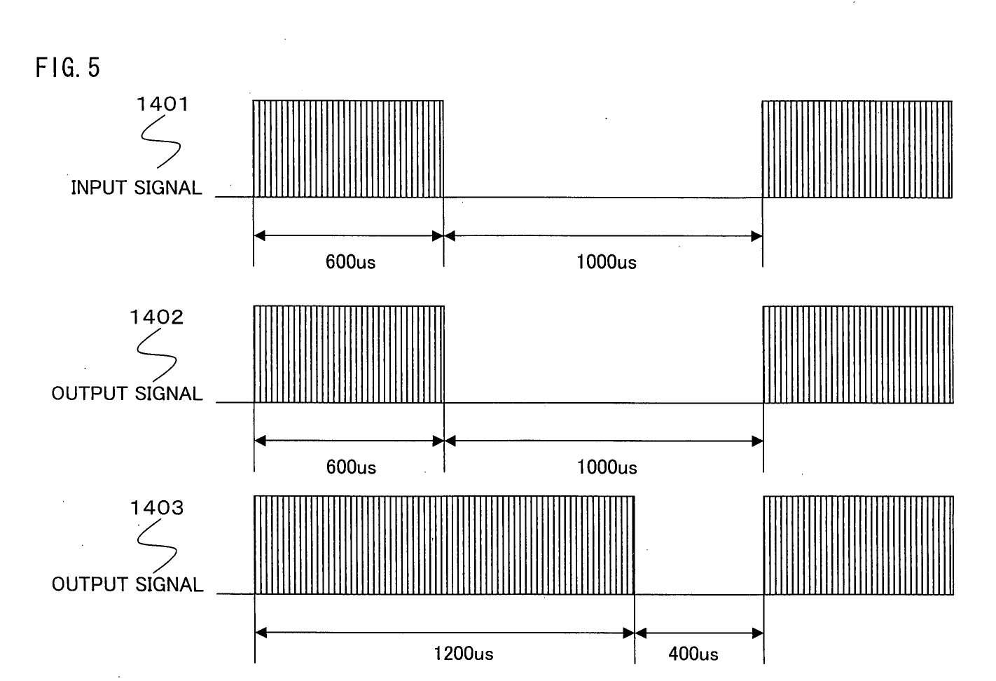

That is, as illustrated in FIG. 5, when an input signal 1401 is inputted, an output signal is outputted with a pulse width which falls within a range from 1402 to 1403. As described, when the signal has a pulse of 600 μs, there is a possibility that the pulse width is varied (distorted) by approximately 600 μs at a maximum. This possibility however is based on the specification value, and the possibility of such variation, in an actual environment, is small. It will be reasonable to assume that possible variation in the pulse width would be approximately 100 μs to 200 μs.

In many cases, a pulse width of an actually-used pulse is shorter than 600 μs, and is 350 μs to 500 μs, as such the distortion in the pulse would be slightly smaller. However, the possible variations actually taking place in the pulse width would be the foregoing value. Accordingly, “predetermined pulse width” which appears in the present embodiment is a pulse width of about 350 μs to 500 μs which is found out in consideration of various specifications. Similarly, “predetermined value”, by which a pulse width is reduced or lengthened, is a value of approximately 100 μs to 200 μs or a value of 600 μs at a maximum which is found in consideration of various specifications.

In view of the circumstances, the “predetermined pulse width” (reference pulse width or a first reference value) is determined as (A) a minimum value (e.g., 350 μs) within a range of an actually-used pulse width, or (B) a value (e.g., 300 μs) which is surely below the minimum value. The predetermined pulse width is stored in the reference value storage section 108, and a process similar to aforementioned waveform shaping specialized for remote-control symbols of the company A is carried out. In this way, it is possible to carry out the waveform shaping regardless of specification.

Note that an application of the present invention is not limited to an infrared remote control. Namely, the present invention may be applied to various intended purposes (signal processing). With the present invention, it is possible to carry out a suitable waveform shaping for the respective various intended purposes. That is, the present invention can be implemented not only on as order, but also on various orders such as ns (nano second) order, or ms order.

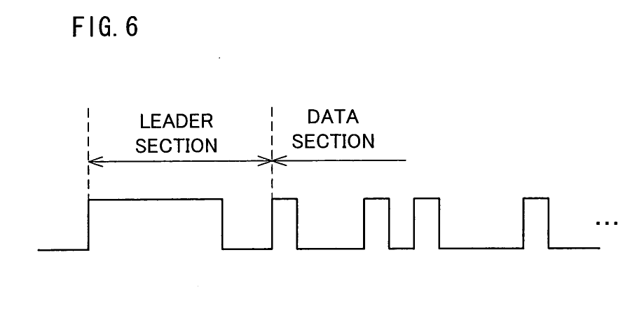

Further, in a general information communication, data is transmitted in a form of packet. At the headmost portion of the packet, there is a section called start flag or called a leader section, as illustrated in FIG. 6, and the data is arranged to follow this section. By interpreting the leader section or the like, it is possible to identify what symbol (standard) of what maker.

Accordingly, as illustrated in FIG. 9, the following example is possible. Namely, the input signal 101 is sent to the control section 107, and the remote control symbol (standard) and/or the maker may be identified by the control section 107 based on the start flag or the leader section. Based on the remote control symbol (standard) and/or the maker which has been identified, a predetermined pulse width of a pulse to be included in the packet is specified. The predetermined pulse width thus specified is stored in the reference value storage section 108. Of course, alternatively, it is possible to inform (supply) to the control section 107, by user input, of the predetermined pulse width before the information communication is carried out, via an input section 109 or a communication section 110.

Further, there is also a demand for a waveform shaping without specifying the predetermined pulse width. In this case, it may be possible to use a minimum pulse width in the received packet as the predetermined pulse width, or to determine the predetermined pulse width as a pulse width slightly smaller than the minimum pulse width in the received packet.

Note that the minimum pulse width can be found by finding a minimum bit number among the bit numbers corresponding to the pulse widths which are obtained by a sampling data analyzing section 104a. The bit number corresponding to the pulse width can be obtained by counting the number of bits from a rising edge to a falling edge, each of the edges being detected from bit strings of a sampling signal 103.

Further, it may be possible to respond to a change in communication environments by finding the minimum pulse width on a packet-by-packet basis, and by varying, for every packet, the predetermined pulse width stored in the reference value storage section 108. Alternatively, in a case where the communication environment is anticipated to be stable, it may be possible to store, in the reference value storage section 108, the minimum pulse width which is first to be obtained as the predetermined pulse width. Alternatively, it may be possible to periodically find the minimum pulse width.

Incidentally, the waveform shaping is carried out to reproduce the predetermined pulse width, which is not to say that the waveform shaping can give rise to a complete reproduction of the predetermined pulse width. This is because every pulse width is not necessarily a multiple number of a sampling intervals of the sampling clock 106, and is further because the accuracy of the sampling clock 106 is slightly different from device to device. For example, it is not possible for the waveform shaping to obtain the predetermined pulse width if (a) the sampling clock 106 is 10 kHz (sampling interval=100 μs), and (b) the predetermined pulse width is 250 μs. This is because, when the pulse width of 250 μs is sampled at the sampling interval of 100 μs, the pulse width is sampled three times or only twice, depending on a timing of sampling. Accordingly, a detected pulse width results in either 200 μs or 300 μs.

Therefore, in this case, the waveform shaping causes a pulse width of 200 μs or 300 μs, which is the closest to the predetermined pulse width. Whether a pulse width of 200 μs or 300 μs is obtained depends on mounting (packaging). For example, if a characteristic of the infrared receiving section 301 such as a remote-control light-receiving unit has a strong tendency to lengthen pulse widths, then the waveform shaping may be carried out to obtain a pulse width of 200 μs. If a sensitivity of the light-receiving unit is poor, the waveform shaping may be carried out to obtain a pulse width of 300 μs. In other words, if a tendency of distortion due to a signal processing is previously known, it is possible to store, in the reference value storage section 108, a predetermined pulse width suitable for the tendency. Further, it may be possible to read a predetermined pulse width which is previously stored in the reference value storage section 108, in accordance with the level of sensitivities of the infrared receiving section 301 (strength of the received signal) which are obtained by the control section 107.

### Embodiment 4

The Embodiment 3 deals with the case where there may be variations in lengthening width of the pulses. The variations often occur in an occasion where communication environments (communication distance, light emitting power, and/or the like) are always varying.

However, it may be assumed that the communication environments are substantially unchanged in terms of short periods of time. The short periods of time correspond to a single packet unit, or several packets which are outputted upon pressing a button of a remote control. On this account, there may be a case where the lengthening widths of the pulses are substantially fixed.

For example, as illustrated in FIG. 22, when a user in a room of a typical house operates a remote control 209, directing the remote control 209 towards a television 207, it is possible to assume that the communication environments are substantially fixed. As such, the lengthening width of the pulses can be assumed to be substantially fixed.

In this case, it may be possible to carry out a waveform shaping in which all of the pulses are shortened by a predetermined amount, instead of carrying out a waveform shaping to always obtain an identical pulse width. In some cases, the mounting is made simpler and a cost needed for a system may be reduced, by carrying out the waveform shaping with respect to each predetermined width of all the pulses, as compared with the waveform shaping to obtain an identical pulse width.

For example, in order to carry out the waveform shaping with respect to all the pulses to obtain the identical pulse width, a comparing section 104b (See FIG. 9) is needed for (i) comparing a detected pulse width with a reference pulse width, and (ii) determining the amount of the pulse width to be increased or decreased. Such a comparing section 104b is not needed in the case of, carrying out the waveform shaping with respect to the predetermined width regardless of the pulse widths. Accordingly, the mounting can be made simpler in the latter case.

Note that, even in the case of the communication environments under which the variations in the pulse widths constantly occur, it is possible to determine a range of variations (e.g., approximately 100 μs to 200 μs) by previously estimating the range of the variations based on measurement data and the like, as described before. Thus, no matter how long a pulse width of a pulse in an input signal 101 (See FIG. 2(a)) is, the pulse width may be increased or decreased by a constant increasing or decreasing amount, after appropriately determining the increasing or decreasing amount which surely acquires a desirable result of the waveform shaping.

### Embodiment 5

In the foregoing Embodiments 1 through 4, it is assumed that a pulse is basically lengthened backwards on a time-basis. This is true under typical communication circumstances, however, the pulse width may be shortened in certain circumstances. Such circumstances may be when a communication distance is long, or when light emitting power is weak because a battery of a remote control is running out.

In these circumstances, a pulse width outputted from an infrared receiving section 301 tends to be shortened. In these circumstances, it is possible to make a waveform of the pulse closer to an original waveform by carrying out a waveform shaping in which, when received power which is always or intermittently detected is smaller than a reference value, the pulse width is lengthened by a predetermined amount, or all of the pulse widths are lengthened up to a predetermined value.

In this case, for example, when the received power which is detected by the infrared receiving section 301 becomes below the reference value, this situation may be reported to a control section 107. When it is reported to the control section 107, by the infrared receiving section 301, that the reception power has become below the reference value, the control section 107 reads out a constant value, for use in lengthening the pulse width, which is stored in a reference value storage section 108. Then, the control section 107 outputs, to a data processing section 104c, the constant value. Upon reception of the instruction from the control section 107, the data processing section 104c carries out a data process for lengthening, by the predetermined amount, all of the pulse widths regardless of actual widths of the respective pulses.

### Embodiment 6

As in the foregoing cases, a pulse width outputted from an infrared receiving section 301 may vary. Further, the pulse width is more likely to lengthen by various amounts. In short, it is possible to assume that a pulse width which is the shortest amongst pulses in a sampling signal, is the closest one to an original pulse width.

This can apply not only to a pulse width fixing method, but also to a pulse interval fixing method. For example, when changing a pulse width into T or 2T, a minimum pulse width of T and a minimum pulse width of 2T can be obtained by searching the minimum pulses of the respective pulse widths with the use of a sampling data analyzing section 104a.

Thus, by making the pulse widths of the pulses in the sampling signal 103 close to the minimum pulse width, it is possible to make the waveforms close to the original ones, respectively. Here, it is described that the pulse widths of the pulses in the sampling signal 103 are made close to the minimum pulse width, and not that the pulse widths of the pulses in the sampling signal 103 are made coincident with the minimum pulse width. This is because, as described before, it may not be possible to make the pulse width in the sampling signal 103 coincident with the original pulse width due to an accuracy and/or a cycle of the sampling clock 106.

Note that a configuration of a waveform shaping device for finding the minimum pulse width is already described in Embodiment 3.

### Embodiment 7

As in the foregoing cases, a pulse width outputted from an infrared receiving section 301 may vary. Further, the pulse width is more likely to lengthen by various amounts. In short, it is possible to assume that a pulse width which is the shortest amongst pulses in a sampling signal, is the closest one to an original pulse width.

However, in some cases, even the pulse having the shortest pulse width is lengthened more than an original pulse. In this case, the pulse may be made closer to the original waveform by so correcting the pulse that the pulse is shorter than the shortest pulse width.

Here the following describes a meaning of “equal to or less than” as in “set equal to or less than the minimum pulse width”. As already mentioned, the pulse width of the original signal and a pulse width resulting from a waveform shaping carried out with a use of a sampling clock 106 may not be coincident with each other. As in the foregoing example, for example, if (a) the sampling clock 106 is 10 kHz (sampling interval=100 μs), and (b) a predetermined pulse width is 250 μs, a pulse width of the sampling signal 103 is not coincident with the predetermined pulse width. This is because the pulse width of the sampling signal 103 is in units of 100 μs, after the waveform shaping is carried out.

Therefore, in this case, a waveform shaping is usually carried out with respect to the pulse to have a pulse width of 200 μs or 300 μs, which pulse width is the closest to the predetermined pulse width. What should be concerned here is which pulse width of 200 μs or 300 μs should be selected during the waveform shaping.

As is described in the section of BACKGROUND ART, the pulse width of the pulse outputted from the infrared receiving section 301 tends to lengthen. An infrared receiving section is also provided in a tuner 202 illustrated in FIG. 22. When supposing that there is a chance that the pulse width may lengthen in this infrared receiving section as well, in the waveform shaping here, it is preferable that the waveform shaping be carried out to have the pulse width of 200 μs rather than the pulse width of 300 μs, where the predetermined pulse width is 250 μs. In short, it is preferable that the waveform shaping be carried out to have a pulse width which is equal to or less than the minimum pulse width.

Further, in the waveform shaping, a pulse width can not be shorter than an inverse number of a frequency of the sampling clock 106. That is, if the sampling clock is 10 kHz, then a sampling interval is 100 μs. In this case, a minimum pulse width obtained after the waveform shaping is carried out is 100 μs. A waveform shaping may be carried out to have a minimum pulse width which is derived from the sampling clock 106, regardless of the original pulse width.

The frequency of the sampling clock 106 is usually a fixed value. Therefore, in this case, a sampling interval, derived from the inverse number of the frequency of the sampling clock 106, is stored as the predetermined pulse width in the reference value storage section 108.

### Embodiment 8

Each of the foregoing embodiments basically deals with a case where a waveform shaping is carried out with respect to all of pulses in a sampling signal 103. However, the present invention is not limited to such a case.

For example, in the case of Embodiment 6, the waveform shaping does not necessarily have to be carried out with respect to a pulse having a minimum pulse width. In short, the waveform shaping may be carried out, only when a predetermined condition is met.

A pulse width of a pulse outputted from an infrared receiving section 301 is sometimes varied. Further, even if the variations in the pulse widths of the pulses outputted from the infrared receiving section 301 are insignificant, the pulse width may be varied depending on an accuracy and/or a frequency of the sampling clock 106 in the sampling section 102.

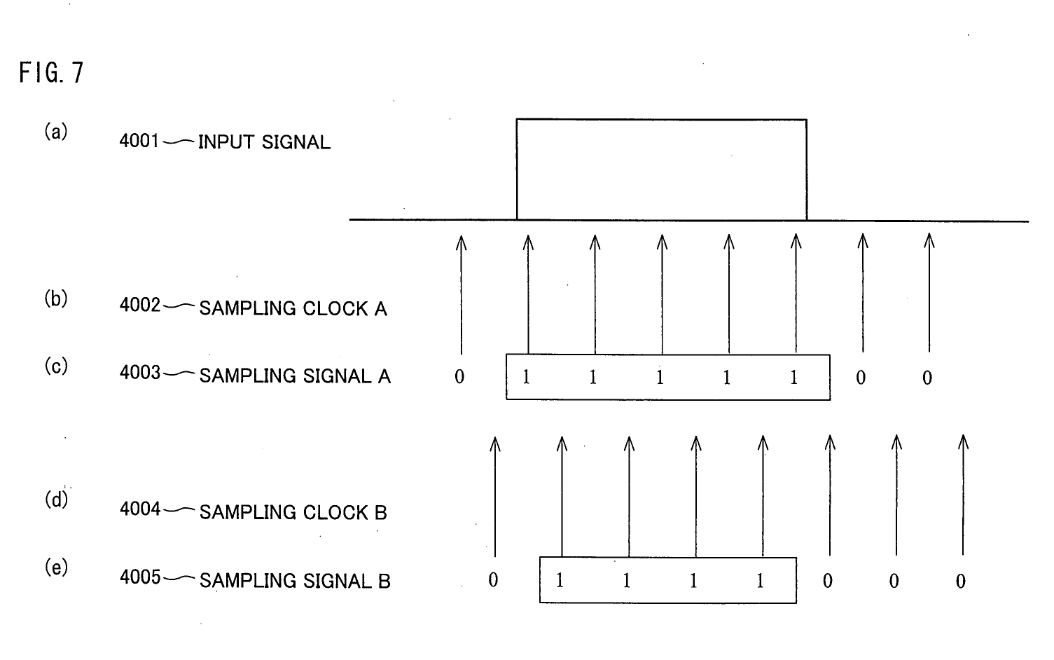

Generally, the sampling clock 106 is not synchronized with an input signal (infrared receiving section output signal) 101. Accordingly, as illustrated in FIG. 7(a) to FIG. 7(e), for an input signal 4001, there are a plurality of clock timings for sampling the input signal 4001; e.g., a sampling clock A 4002, a sampling clock B 4004, and so on.

As such, a plurality of sampling signals, such as a sampling signal A 4003 and a sampling signal B 4005 are obtained. As it is obvious from these sampling signals, the sampling signals obtained from the same input signal 4001 may differ from each other.

In this case, it is possible to make a pulse closer to an original waveform, by carrying out the waveform shaping only when a certain condition (e.g., a pulse width is longer than a predetermined pulse width) is met. For example, in the case illustrated in FIG. 7(a) to Fig. (e), the waveform shaping is carried out only with respect to the sampling signal A; i.e., only when the pulse width is stretched as a result of sampling. Further, in a case where the pulse width tends to be shortened as in Embodiment 5, it is possible to carry out a waveform shaping that stretches the pulse width, only when the pulse width is less than the predetermined pulse width. In short, the waveform shaping may be carried out only when the pulse width is not in a predetermined range (a standard range previously determined and stored in a standard value storing section 108).

Further, as illustrated in FIG. 6, a remote control signal in general is often separated into a leader section and a data section when being transmitted. In this case, the waveform shaping may be % carried out only with respect to a pulse in the data section, and not with respect to the leader section. In short, by allowing an arbitrary setting of pulse subject to the waveform shaping, it is possible to realize a waveform shaping suitable for actual conditions.

### Embodiment 9

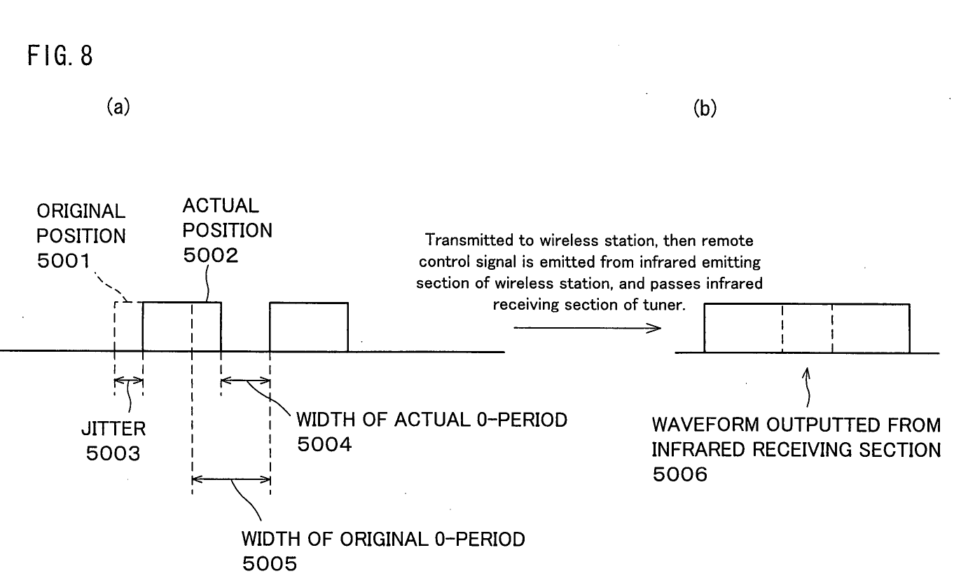

As illustrated in FIG. 8(a), a pulse outputted from an infrared receiving section 301 is supposed to be in a position 5001. However, due to jitter 5003, there is a case where the pulse is in a position 5002, which is different from the position 5001. In such a case, a no-pulse period may become shorter, although a pulse width itself is not varied.

If (i) a signal whose no-pulse period is shortened is sampled, and (ii) the signal is then transmitted to a wireless station 204 and is inputted to an infrared receiving section of a tuner 202, adjacent pulses may be combined with each other, thus forming a single pulse having a large pulse width (See output waveform 5006 illustrated in FIG. 8(b)).

In this case, a remote control signal may not be properly transmitted, even if the pulse width itself being received at the infrared receiving section 301 of a television 207 is a predetermined pulse width.

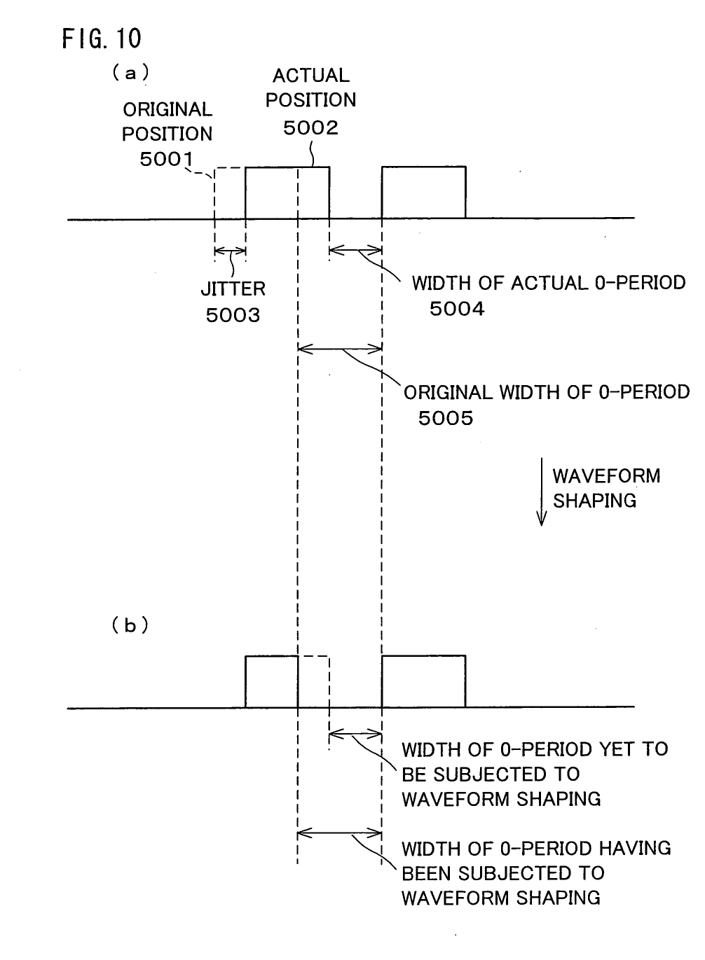

Accordingly, if a no-pulse (0) period is shorter than a predetermined width as illustrated in FIG. 10(a), the no-pulse (0) period is made equal to or longer than the predetermined value (See FIG. 10(b)), even if the pulse width is the predetermined pulse width. This enables a proper transmission of the signal.

Consequently, the pulse width may become shorter than the predetermined pulse width. However, the foregoing case gives priority to the no-pulse period (i.e., pulse interval), rather than to the pulse width. Further, if the pulse width becomes shorter than the predetermined pulse width as a result of causing the no-pulse period to become equal to or longer than the predetermined value, the pulse width is shifted forward or backward, instead of correcting the pulse width. In this way, it is possible to obtain a desirable pulse width as well as a desirable no-pulse period.

In order to adopt this method, a standard bit number (reference interval value) indicating a standard no-pulse period; i.e., a standard pulse interval, is stored in a reference value storage section 108. A comparing section 104b successively compares (a) the bit numbers respectively corresponding to the pulse intervals found by the sampling data analyzing section 104a (e.g. number of continuous codes of “0”) with (b) the standard bit number being read out, by a control section 107. Then, in a case where the bit number corresponding to the pulse interval is below the standard bit number, the comparing section 104b calculates out a number of bits to be increased or decreased. A result of the calculation is passed on to a data processing section 104c, so that the data processing section 104c can carry out a process for increasing, up to the standard bit number, the bit number which is less than the standard bit number, the bit number corresponding to the pulse interval.

Note that, in a case of correcting the pulse interval of data whose pulse width has been corrected by using the data processing section-104c, the foregoing process may be carried out after re-entering the output from the data processing section 104c to the sampling data analyzing section 104a.

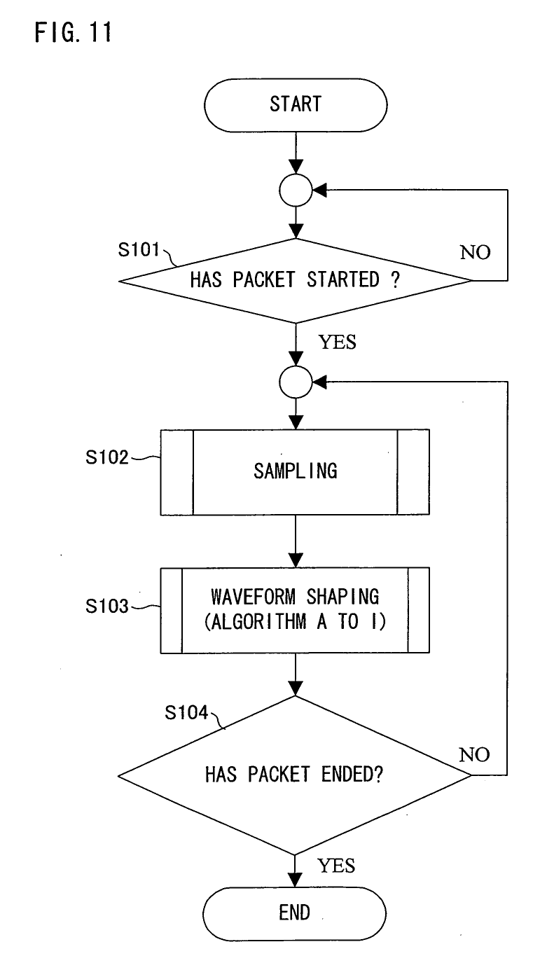

The following describes, with reference to a flowchart shown in FIG. 11, the waveform shaping method described in the foregoing embodiments. First, the control section 107 waits for a packet (input signal 101) to be inputted (S101). Upon recognition of a start of the packet input, the control section 107 causes the sampling section 102 to carry out a sampling (S102). Then, the control section 107 causes a waveform shaping section to carry out a waveform shaping in line with at least one of the waveform shapings described in the foregoing embodiments (S103). The control section 107 repetitively executes the steps S102 to S103 until the packet ends (S104).

In this case, the steps of the flowchart are executed with respect to each packet. However, the present invention is not limited to this. For example, instead of executing the steps of the flowchart with respect to each packet, the steps of the flowchart may be executed continuously, as long as the input signal 101 is inputted. In an actual environment, the sampling section 102 is not capable of predicting when the input signal will be inputted. Further, in order to start the operation upon recognition of the start of the packet input, it is necessary to carry out a process to recognize the start of the packet input.

There are various kinds of the input signal 101 (e.g., remote control signal) that could possibly be inputted. Accordingly, in order to judge whether or not the packet input is started, it is necessary to previously provide a table of, for example, a leader section located at a beginning of the packet. Further, once the table is set, the table needs to be renewed every time new kinds of input signal 101 are registered.

Alternatively, the recognition of the beginning of the packet may be omitted. In this way, it is possible to realize a simple configuration in which any kind of input signal 101 is subjected to waveform shaping, at any time. However, it is not necessary to carry out the waveform shaping with respect to all of the pulses. A suitable waveform shaping may be selectively carried out, in line with the any of the waveform shaping methods described in the foregoing embodiments.

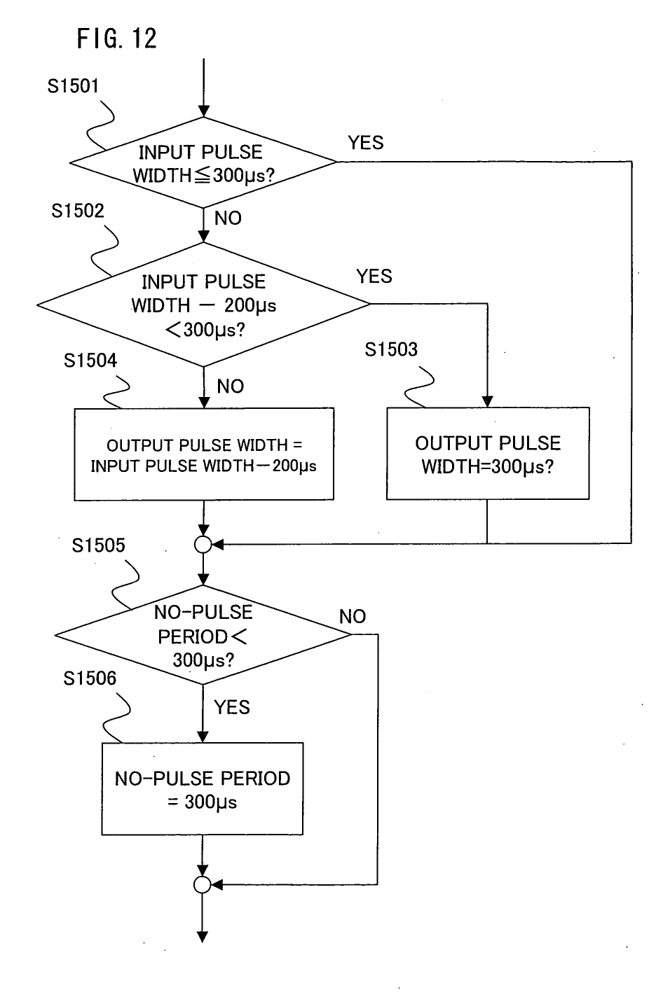

Next, FIG. 12 illustrates an example which provides a detailed explanation for the step S103, shown in FIG. 11, as carried out in the waveform shapings of the foregoing embodiments 4, 8, and 9. In this example, it is supposed that the predetermined pulse width is 300 μs. Upon detection of a pulse whose pulse width is longer than 300 μs, the pulse is shortened by 200 μs or the like.

However, it is supposed that the minimum pulse width is the predetermined pulse width of 300 μs. That is, when the detected pulse width is 300 μs, the waveform shaping is not carried out. On the other hand, when the detected pulse width is over 300 μs and no more than 500 μs, the detected pulse is converted into a pulse of 300 μs, when being outputted.

However, as a result of the waveform shaping, if the no pulse period in succession to the pulse is less than 300 μs, the no pulse period is made 300 μs. It is acceptable even if the pulse width consequently becomes shorter than 300 μs.

First, the control section 107 reads out, from the reference value storage section 108, a bit number that corresponds to the predetermined pulse width (first reference value) of 300 μs. The control section 107 then outputs the bit number to the comparing section 104b. The comparing section 104b confirms whether or not the input pulse width is longer than 300 μs, by using (i) a pulse width having been subjected to an analysis carried out in the sampling data analyzing section 104a, and (ii) a bit number corresponding to a pulse interval (S1501). As already mentioned, the first reference value may be determined as follows. Namely, it is possible to previously determine the first reference value based on measurement data, or the like, of the pulse width. Further, it is also possible to obtain information of the pulse width in the input signal 101, and determine the first reference value on the basis of the information. Moreover, it is possible to find the pulse width of the input signal 101, and determine the first reference value on the basis of the minimum pulse width. Further, it is also possible to determine the first reference value based on an inverse number of a previously-determined sampling frequency.

If the pulse width is 300 μs or less (YES in S1501), the waveform shaping is not carried out in this step, and the process goes to a conditional branch point of S1505. That is, the data processing section 104c does not process the output from the sampling data analyzing section 104a, and the output is re-inputted to the sampling data analyzing section 104a. On the other hand, if the input pulse width is longer than 300 μs (No in S1501), in the S1502, the control section 107 reads out, from the reference value storage section 108, the predetermined value (constant value) of 200 μs. Then, by using a bit number corresponding to the predetermined value, the data processing section 104c reduces the input pulse width by 200 μs, so as to confirm whether or not the shortened input pulse width is shorter than the minimum pulse width (300 μs). In other words, in the process in the step 1502, the data processing section 104c confirms whether or not the input pulse width is shorter than 500 μs (second reference value) which is a sum of 300 μs (first reference value) and 200 μs (constant value).

If the shortened input pulse width is shorter than 300 μs (Yes in S1502); i.e., if a size of the input pulse width is between the first and second reference values, the data processing section 104c carries out the waveform shaping so that the input pulse width is uniformly shaped into a pulse width of 300 μs (S1503). If the shortened input pulse width is 300 μs or longer (No in S1502); i.e., if the input pulse width is 500 μs (second reference value) or longer, the data processing section 104c carries-out the waveform shaping so that the input pulse width is shortened by 200 μs (constant value) (S1504).

After the waveform shaping, the sampling data analyzing section 104a receives the resulting data from the data processing section 104c, and measures the pulse interval; i.e., measures a length of the no-pulse period (S1505). At this point, the control section 107 reads out, from the reference value storage section 108, a bit number corresponding to 300 μs which is the predetermined no-pulse period (reference interval value for determining the pulse interval). The control section 107 then outputs the bit number to the comparing section 104b. By using a bit number indicating the pulse interval having been subjected to the analysis in the sampling data analyzing section 104a, the comparing section 104b confirms whether or not the no-pulse period is shorter than 300 μs (S1505). If the no-pulse period is shorter than 300 μs (Yes in S1505), the data processing section 104c shapes the no-pulse period into a no-pulse period of 300 μs. It is acceptable if the pulse width consequently becomes shorter than 300 μs (first reference value). That is, in this case, it is the specification of the no-pulse period which is given priority, rather than the specification of the pulse width (See FIGS. 10(a) and (b)).

Note that the reference interval value may be determined as follows. Namely, it is possible to previously determine the reference interval value based on measurement data or the like of the pulse interval. Further, it is also possible to obtain information of the pulse interval in the input signal 101, and determine the reference interval value on the basis of the information. Moreover, it is possible to find the pulse interval of the input signal 101, and determine the reference interval value on the basis of the minimum pulse interval. Further, it is also possible to determine the reference interval value based on an inverse number of a previously-determined sampling frequency.

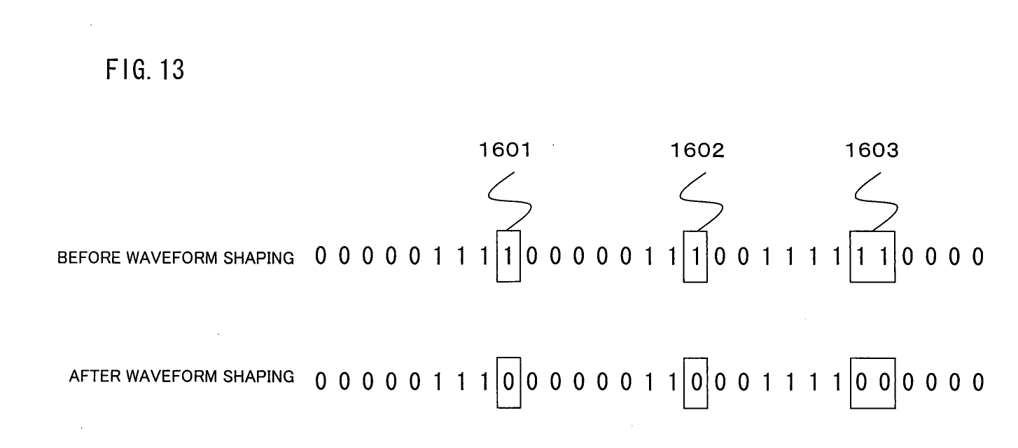

FIG. 13 explains how the waveform shaping is carried out in the processes shown in the flowchart of FIG. 12. In FIG. 13 illustrated are (i) a waveform which is yet to be subjected to the waveform shaping in the process shown in the flowchart of FIG. 12 and (ii) a waveform which has been subjected to the waveform shaping. As illustrated in FIG. 13, first, a pulse width (400 μs), which is longer than 300 μs (first reference value) is detected at 1601. If this pulse is shortened by 200 μs (constant value), the pulse width becomes 200 μs. This is smaller than 300 μs. Therefore, one of consecutive bits of “1” is reduced, so that the pulse width is shaped into the minimum pulse width of 300 μs (first reference value) (process of S1503).

Next, at 1602, the waveform shaping is not carried out since the pulse width is 300 μs (first reference value). However, a no-pulse period following the pulse width is 200 μs, and is smaller than 300 μs (reference interval value). Therefore, a number of consecutive bits of “0” is increased by one. In other words, the number of bits of “1” converted from the preceding pulse width is decreased by one, thereby making the no-pulse period 300 μs (reference interval value). Consequently, the pulse width is 200 μs, and is smaller than the first reference value (process of S1506).

Next, a pulse width (600 μs) which is longer than 300 μs (first reference value) is detected at 1603. This pulse width is still larger than 300 μs (first reference value), even if the pulse width is reduced by 200 μs (constant value). That is, the pulse width is longer than the second reference value of 500 μs. Accordingly, the number of consecutive bits of “1” of the pulse width are reduced by two to shorten the pulse width by 200 μs (constant value) (process of S1504). Thus, the pulse width of 600 μs is shortened to 400 μs.

As described, the waveform shaping illustrated in FIG. 13 is basically as follows. Namely, when a pulse width is equal to or larger than the second reference value, the pulse width is reduced by a constant value. When the pulse width is between the first reference value and the second reference value, the pulse width is coincided with the first reference value. Further, when the pulse width is equal to or less than the first reference value, the pulse width is not subjected to the waveform shaping.

Further, the length of the no-pulse period is found in all of the cases. If the length of the no-pulse period does not satisfy the reference interval value, the pulse width is further reduced, so that the length of the no-pulse period is coincided with the reference interval value. A waveform shaping for correcting the no-pulse period is preferably standardized to one of (i) a waveform shaping which reduces only a falling part of a pulse width positioned ahead of the no-pulse period, or (ii) a waveform shaping which reduces only a rising part of a pulse width following the no-pulse period. Particularly in the case of infrared communication, it is more preferable that the waveform shaping for correcting the no-pulse period be standardized to the waveform shaping which reduces only the falling part of the pulse width positioned ahead of the no-pulse period.

As described, when the waveform shaping is carried out in line with the flowchart of FIG. 12, even if the predetermined pulse width is determined as the first reference value of 300 μs, the pulse width of pulses are not uniformly 300 μs, after the waveform shaping is carried out. As illustrated in FIG. 13, the waveform shaping results in non-uniform pulse widths, and the pulse widths may be, for example, 200 μs, 300 μs, or 400 μs, depending on conditions of the no-pulse period and the pulse width.

However, the non-uniform pulse widths do not raise any problems as long as the waveform shaping for correcting the no-pulse period is standardized to one of (i) the waveform shaping which reduces the falling part of the pulse width positioned ahead of the no-pulse period, or (ii) the waveform shaping which reduces the rising part of the pulse following the no-pulse period.

This is because, for example, in the waveform shaping which reduces the falling portion of the pulse preceding the no-pulse period, positions of rising edges of respective pulses remain unchanged as illustrated in FIG. 3(b) and FIG. 3(c). In short, intervals between the rising edges are not changed. Accordingly, despite the uneven pulse widths, it is advantageous in ensuring the length of the no-pulse period. Thus, an original signal is accurately reproduced, based on the rising edges of the respective pulses.

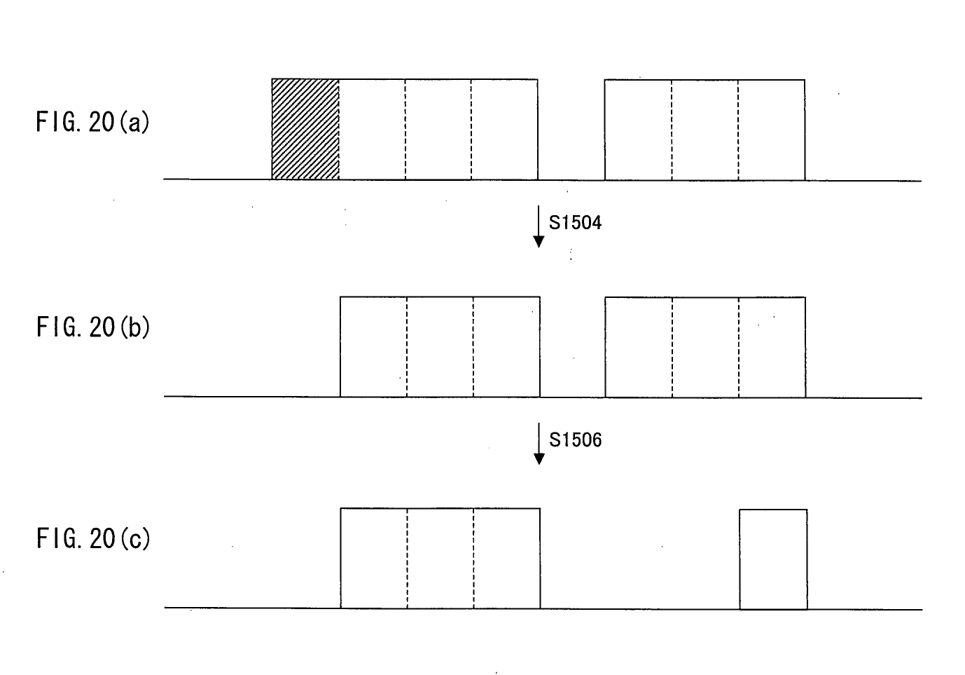

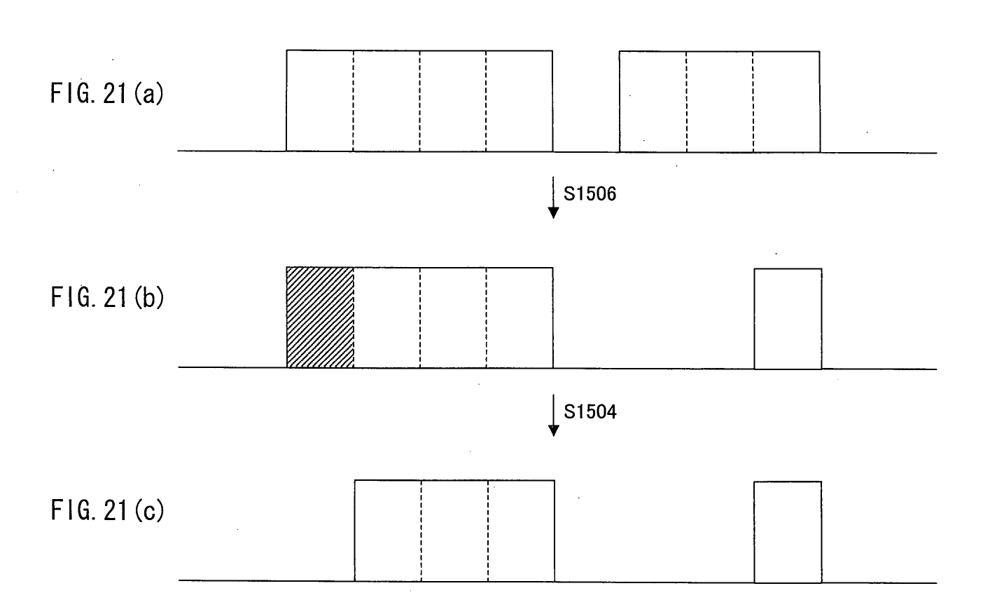

Further, in the waveform shaping which reduces the rising portion of the pulse in succession to the no-pulse period, positions of falling edges of respective pulses remain unchanged. In short, intervals between the falling edges are not changed. Accordingly, this is suitable for a waveform shaping carried out in a case of performing signal processing in which distortion is more likely to occur at a rising edge of a pulse, rather than a falling edge of the pulse. As in the foregoing case, an original signal is accurately reproduced, based on the falling edges of the respective pulses. This is described later, with reference to FIG. 20(a) to FIG. 20(c), and FIG. 21(a) to FIG. 21(c).

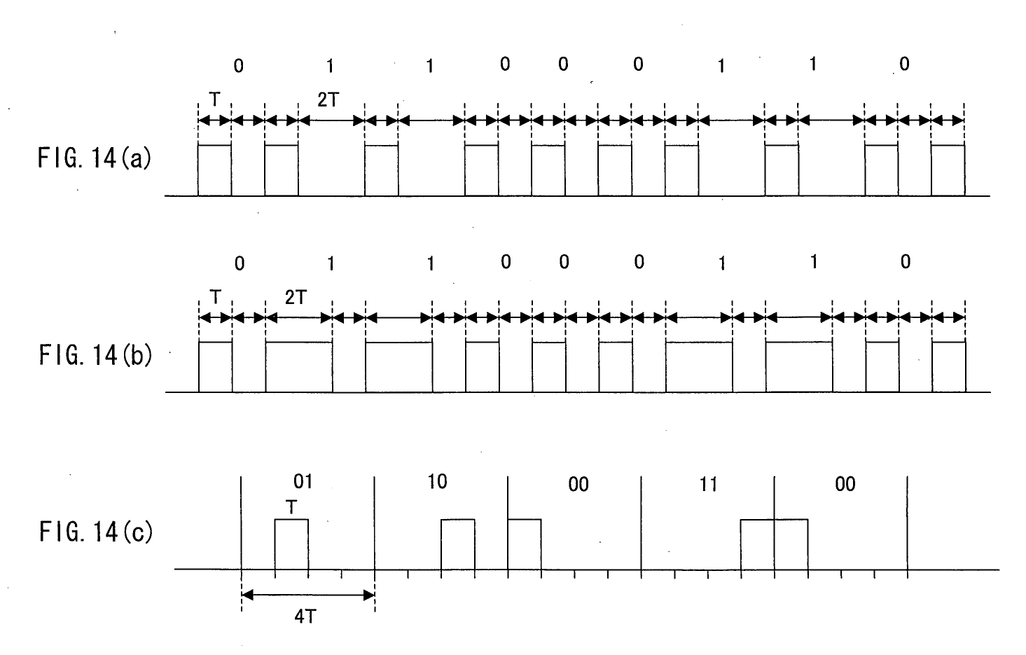

Incidentally, there are various modulation methods involving a remote control signal. However, in general, the following three methods illustrated in FIG. 14(a) to FIG. 14(c) are often used.

FIG. 14(a) is a modulation method in which the pulse width is fixed, and information is transmitted by varying the pulse interval. FIG. 14(b) is a modulation method in which the pulse interval is fixed, and the information is transmitted by varying the pulse width. FIG. 14(c) is a modulation method in which the pulse width is fixed, and a certain time unit is divided into several sub units (hereinafter referred to as slot). In this method of FIG. 14(c), the information is transmitted by varying which one of the slots the pulse occurs in. For example, as illustrated in FIG. 14(c), if one unit includes four slots, two bits of information can be transmitted by a single pulse.

A level of influence on the data error at an ultimate destination of data (stage of the tuner 202 illustrated in FIG. 23), when the above methods are used and when a distortion occurs in a waveform of a pulse, is described in the following.

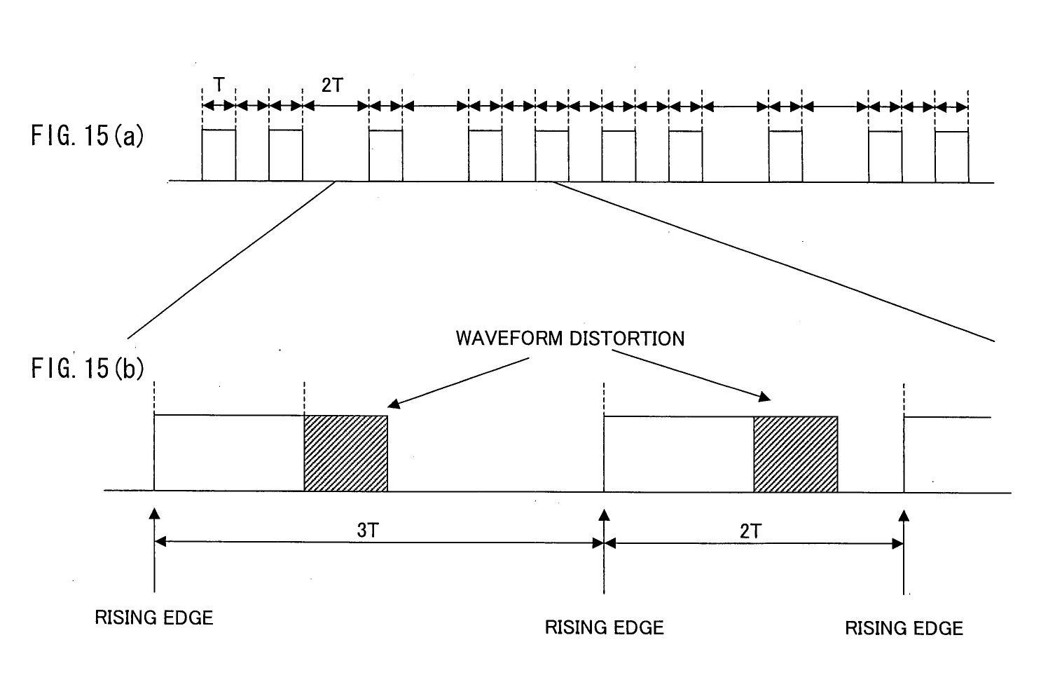

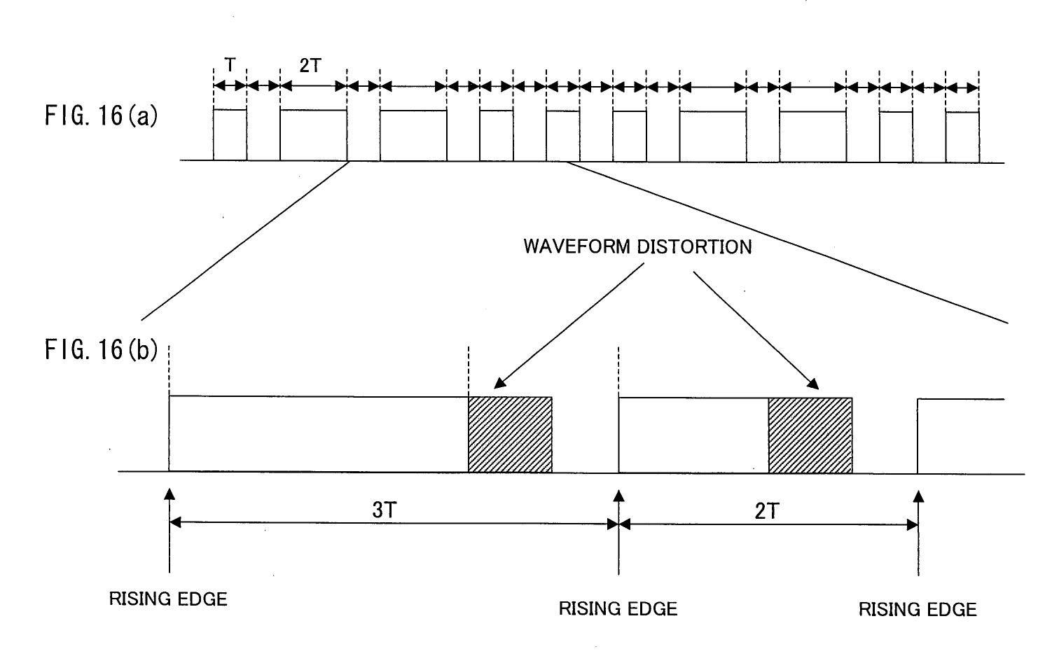

Firstly, the method of FIG. 14(a) and the method of FIG. 14(b) differ from each other on whether the information is transmitted by varying the pulse interval or by varying the pulse width. However, in both of the methods, it is possible to assume that a period between a rising edge of one pulse and another rising edge of another pulse is constant. Accordingly, in these methods, the data can be decoded on the basis of the period between the rising edges (See FIGS. 15(a)(b) and FIGS. 16 (a) (b)), unless adjacent pulses are combined with each other thus eliminating the pulse interval therebetween. Accordingly, with the present invention, a disappearance of the pulse interval is prevented by optimizing the pulse width and the pulse interval. This is advantageous in that a decoding accuracy is improved.

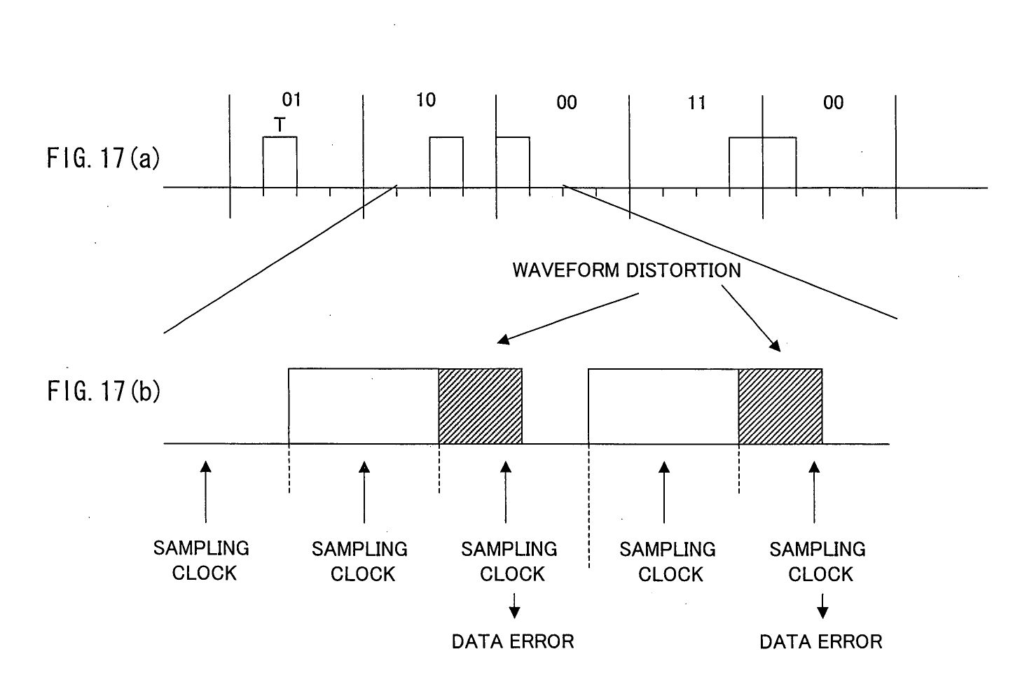

Meanwhile, in the method of FIG. 14(c), the information is transmitted by varying which one of the slots the pulse occurs in. Accordingly, each of the slots is sampled to find out which one of the slots the pulse has occurred in. In this method, a slot which should be sampled as “0” may be sampled as “1”, when a distortion causes a pulse to be stretched. Therefore, data errors are likely to occur (See FIGS. 17(a)(b)). That is, the data error occurs more easily in the modulation method of FIG. 14(c) than it does in the modulation methods of FIG. 14(a) or FIG. 14(b). Accordingly, the present invention, when applied to the modulation method of FIG. 14(c), results: in a more remarkable effect in improving the decoding accuracy.

Next, the following describes, an order of carrying out the steps from S1501 to S1504 of FIG. 12, and the steps from S1505 to S1506 of FIG. 12. In general, a result of waveform shaping may vary depending on whether the waveform shaping is carried out with respect to a leading part or a trailing part of a pulse. However, as already mentioned, by determining which one of the leading part or the trailing part is subjected to the waveform shaping, the result of the waveform shaping is not varied by the order of carrying out the steps from S1501 to S1504 of FIG. 12 and the steps from S1505 to S1506 of FIG. 12. The figures referred in the following are simplified for convenience of explanation.

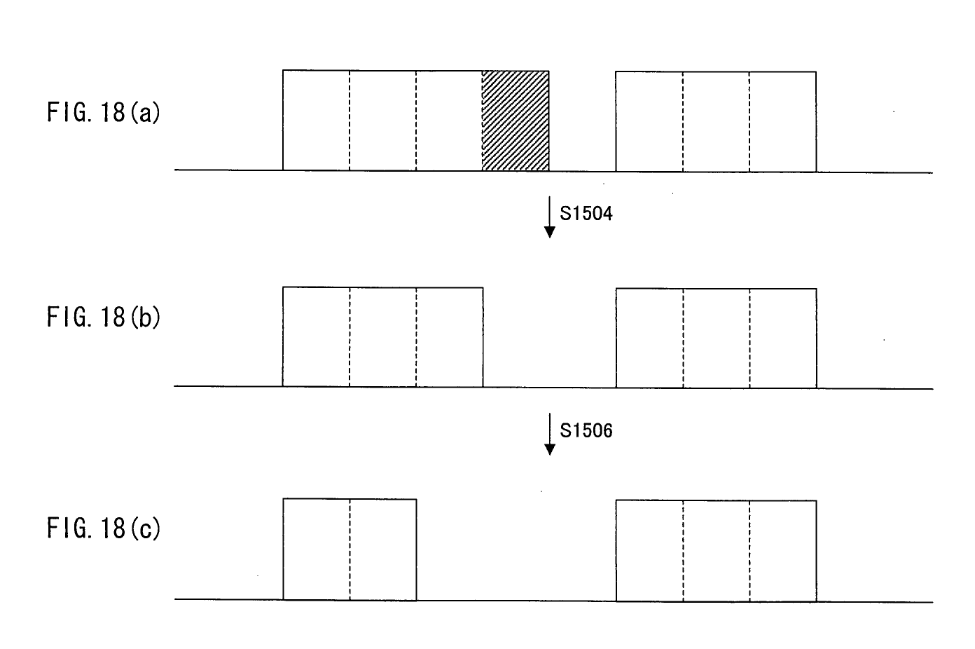

For example, it is determined that the waveform shaping is carried out with respect to the trailing part of the pulse. The pulse is first shortened by trimming its trailing part through the steps from S1501 to S1504. Next, through the steps from S1505 to S1506, the trailing part of the pulse is further trimmed so that the pulse interval is stretched up to the reference interval value. The result of this process is illustrated in FIG. 18(a) to FIG. 18(c).

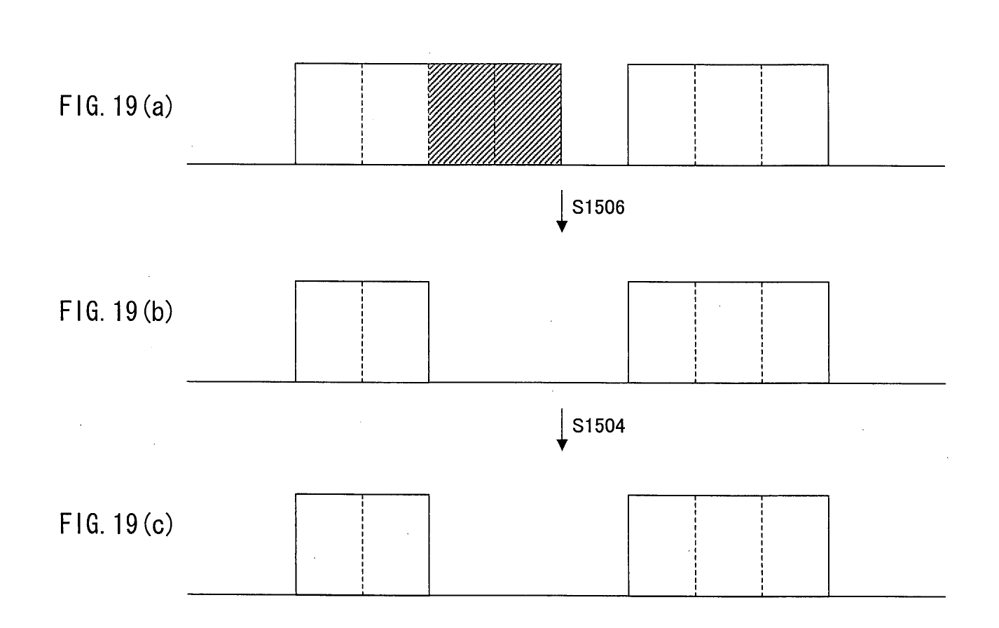

Meanwhile, if the trailing part of the pulse is trimmed through the steps from S1505 to S1506, so that the pulse interval is stretched up to the reference interval value. Then, the pulse width of the pulse is processed through the steps from S1501 to S1504. The result of this process is illustrated in FIG. 19(a) to FIG. 19(c).

As it becomes apparent by comparing these cases, the results are identical to each other, although the order of carrying out the steps from S1501 to S1504 and the steps from S1505 to S1506 are switched over.

Alternatively, it is determined that the waveform shaping is carried out with respect to the leading part of the pulse. In this case, the pulse is first shortened by trimming its leading part through the steps from S1501 to S1504. Next, through the steps from S1505 to S1506, the leading part of a following pulse is trimmed so that the pulse interval is stretched up to the reference interval value. The result of this process is illustrated in FIG. 20(a) to FIG. 20(c).

Meanwhile, the leading part of the pulse is trimmed through the steps from S1505 to S1506, so that the pulse interval is stretched up to the reference interval value. Then, the pulse width of the pulse is processed through the steps from S1501 to S1504. The result of this process is illustrated in FIG. 21(a) to FIG. 21(c).

As it becomes apparent by comparing these cases, the results are identical to each other, although the order of carrying out the steps from S1501 to S1504 and the steps from S1505 to S1506 are switched over.

However, the results of the processes are different when comparing the result of FIGS. 18(a) to 18(c) (or the result of FIGS. 19(a) to 19(c)) with the result of FIGS. 20(a) to 20(c) (or the result of FIGS. 21(a) to 21(c)). That is, the position of the rising edges of the pulses are conserved in the case of subjecting the trailing part of the pulse to the waveform shaping, while the positions of the falling edges of the pulses are conserved in the case of subjecting the leading part of the pulses to the waveform shaping. Accordingly, in a case of such a signal processing that distortion occurs in the falling part of the pulse, it is suitable to shape the pulse by reducing the trailing part thereof. On the contrary, in a case of such a signal processing that distortion occurs in the rising part of the pulse, it is suitable to shape the pulse by reducing the leading part thereof. These methods may be selectively used depending on a characteristic of the signal processing.

In general, the waveform shaping is preferably carried out with respect to the trailing part of the pulse, in the case of using a remote control light receiving unit or the like. This is because the remote-control light receiving unit has such a characteristic that jitter is more likely to occur at the falling part of the pulse than the rising part of the pulse.

(a) As described, a waveform shaping method of the present invention includes: a sampling step for generating a sampling signal by sampling an input signal using a sampling clock which is faster than a data speed of the input signal; and a waveform shaping step for processing the sampling signal, so that a pulse in the input signal, recognized from the sampling signal, is shaped.

With the method, it is possible to shape the pulse by carrying out a simple process, such as a process of increasing or decreasing a bit number, with respect to the sampling signal corresponding to the pulse of the input signal. As such it is possible to use a simple method for realizing a waveform shaping which properly reproduces and restores an original input signal, after the original input signal is transmitted.

(b) The foregoing waveform shaping method may be so adapted that, in the waveform shaping step, waveform shaping is carried out by processing a part of the sampling signal, corresponding to a trailing side of the pulse in the input signal.

When the pulse in the input signal is being transmitted, a trailing side of the pulse is easily deformed. However, in the foregoing method, the waveform shaping is carried out with respect to a part of the sampling signal corresponding to the deformed side. Accordingly, it is possible to more accurately obtain the original input signal.

(c) The foregoing waveform shaping method may be so adapted that, when the input signal is a pulse signal generated through a signal processing carried out with respect to an original pulse signal on which the input signal is based, in the waveform shaping step, waveform shaping is carried out by making a pulse width, which is recognized from the sampling signal, of the input signal closer to a predetermined pulse width.

Further, the method may be so adapted that, when the input signal is a pulse signal for use in a fixed-pulse-width method, the predetermined pulse width is a value close to a lower limit value of a possible pulse width range.

When the predetermined pulse width is set at a value close to an upper limit value, instead of the lower limit value, the pulse width is more likely to be stretched. This causes a no-pulse period to be reduced, thus hindering the restoration of the original pulse width. As a result, a risk of causing a malfunction is increased. On the contrary, by setting the predetermined pulse width at a value close to the lower limit value, the pulse width is more likely to be reduced. Therefore, the no-pulse period is more likely to be guaranteed. Thus, a simple method can be used to prevent of a malfunction.

(d) Further, the foregoing waveform shaping method may be so adapted that, if the input signal contains information related to the pulse width of the input signal, the information is read out, and the predetermined pulse width is determined based on the information.

For example, if header-information of the input signal contains information of a value of the pulse width (designed value), it is possible to set the predetermined pulse width based on the information. Further, if the header-information contains information needed for specifying a type of the pulse signal, the predetermined pulse width may be set by referring to a table, which is previously prepared, specifying a combination of (i) the type of the pulse signal and (ii) the predetermined pulse width.

(e) Further, when shortening, by a predetermined value, the pulse width of the input signal, the foregoing method may be so adapted that the predetermined value is determined based on (i) a lower limit value of a possible pulse width range of the input signal, and (ii) an inverse number of a sampling clock frequency, and the predetermined value is set less than the lower limit value.

Since the pulse width of the input signal is shortened by the predetermined value, the pulse width may become 0, if the predetermined value is excessively large. This however is prevented by setting the predetermined value to a value less than the lower limit value of the possible pulse width range.

Further, since the pulse width is replaced with a discrete symbol string through the sampling., the process of shaping the pulse recognized from the sampling signal includes: (i) a process of increasing or decreasing the number of symbols (e.g., the number of consecutive logic values of “1”) in the symbol string, or (ii) a process of partially inverting or replacing the symbol string corresponding to the pulse width into/with a symbol string corresponding to a pulse interval. In short, the process of shortening the pulse width includes a symbol count increasing/decreasing process, or a symbol-replacing process. When the symbol count is decreased by 1, or when a symbol is replaced to another symbol, consequently the pulse width is shortened by the sampling interval. As such, the process of shortening the pulse width shortens the pulse width in increments of the sampling interval.

For this reason, it is reasonable to determine the predetermined value based on the sampling interval; i.e., the inverse number of the sampling clock frequency.

(f) The foregoing waveform shaping method may be so adapted that, when the input signal is a pulse signal for use in a fixed-pulse-width method, the pulse signal being generated through a signal processing carried out with respect to an original pulse signal on which the input signal is based, in the waveform shaping step, waveform shaping is carried out by making a pulse width, which is recognized from the sampling signal, of the input signal closer to a smallest pulse width of the input signal, the smallest pulse width being recognized from the sampling signal.

Incidentally, in many cases, the pulse width of the input signal varies, and the pulse width is more likely to increase. Further, in many cases, the amount of the increase in the pulse width varies. In short, it is possible to assume that a pulse width which is the shortest amongst pulses in the input signal, is the closest one to an original pulse width.

Thus, by making the pulse, which is recognized from the sampling signal, of the input signal close to the minimum pulse width, it is possible to make the waveforms close to the original ones, respectively.

(g) The foregoing waveform shaping method may be so adapted that, when the input signal is a pulse signal for use in a fixed-pulse-width method, the pulse signal being generated through a signal processing carried out with respect to an original pulse signal on which the input signal is based, in the waveform shaping step, waveform shaping is carried out by making a pulse width, which is recognized from the sampling signal, of the input signal equal to or less than a smallest pulse width of the input signal, the smallest pulse width being recognized from the sampling signal.

Incidentally, in many cases, the pulse width of the input signal varies, and the pulse width is more likely to increase. Further, in many cases, the amount of the increase in the pulse width varies. Further, in some cases, even the pulse having the shortest pulse width is lengthened more than an original pulse. Thus, as described above, by making a pulse width of the input signal less than a smallest pulse width of the input signal, it is possible to make the waveforms close to the original ones, respectively

(h) Further, the foregoing waveform shaping method may be so adapted that, when the input signal is a pulse signal of a fixed-pulse-width method, the pulse signal being generated through a signal processing carried out with respect to an original pulse signal on which the input signal is based, in the waveform shaping step, waveform shaping is carried out by shaping a pulse width, which is recognized from the sampling signal, of the input signal so that a value of the pulse width is equal to an inverse number of a frequency of the sampling clock.

As already mentioned, when the waveform shaping of the present invention is used for correcting the pulse width, the pulse width is shortened or lengthened in increments of the inverse number of the sampling clock frequency; i.e., the sampling interval. As such, if the pulse width is made equal to the sampling interval, the pulse width is shortened to the minimum pulse width.

In the fixed-pulse-width method, if all of the pulses are shaped into the minimum pulse width, it is possible to easily solve the problem of distortion in the pulse width, the distortion caused by shortening or lengthening of the pulse width. Further, since the pulse width is shaped to the minimum pulse width, it is possible to effectively reduce a risk that adjacent pulses are combined with each other and thereby eliminate the no-pulse period.

(i) Further, the foregoing waveform shaping method may be so adapted that, in the waveform shaping step, waveform shaping is so carried out that a no-pulse period, which is recognized from the sampling signal, is detected; and, if the no-pulse period is less than a setting value, the no-pulse period is made equal to the setting value.

Incidentally, a jitter may cause the pulse of the input signal to be in a position different from a position where the pulse is supposed to be. In this case, the pulse interval between the pulse and an adjacent pulse is shortened, even though the pulse width itself is the same. When such an input signal whose no-pulse period is shortened is transmitted, the adjacent pulses may be combined with each other, and form a single large pulse.

Accordingly, even if the pulse width of the input signal is the predetermined pulse width, (a length of) the no-pulse period is measured. When (the length of) the no-pulse period is shorter than a setting value, (the length of) the no-pulse period is processed (restored) through the waveform shaping, so that the no-pulse period is made to be equal to or longer than the setting value. This enables a proper transmission of the signal, while restraining an error.

In this case, the setting value is preferably determined, taking into account a level of distortion in a pulse width, the distortion mainly attributed to a signal processing. The effect obtained from this is as described in the description regarding how to determine the predetermined value.

Further, in the foregoing waveform shaping method, if the input signal contains information related to a pulse interval of the input signal, a predetermined value is set based on the pulse interval read out from the information.

(j) Further, the foregoing waveform shaping method may be so adapted that, in the waveform shaping step, (i) a judgment is carried out, by referring to the sampling signal, as to whether or not a predetermined condition is satisfied, the predetermined condition indicating that the input signal contains a distortion, and (ii) waveform shaping is carried out when the predetermined condition is satisfied.

In the foregoing method, the predetermined condition may be a condition that the pulse width of the input signal does not fall within a predetermined range.

Further, the foregoing waveform shaping method may be so adapted that, in the waveform shaping step, a width of the pulse in the input signal is compared with a reference range determined based on the width of the pulse; and if the width of the pulse is out of the reference range, waveform shaping is so carried out as to make the width of the pulse be within the reference range.

Incidentally, the pulse width of the input signal may vary. Further, even if the variation is insignificant, the pulse width may be further varied due to an accuracy of the sampling clock, or a sampling clock frequency.

Generally, the sampling clock and the input signal are not synchronized with each other. Accordingly, for an input signal, there are a plurality of clock timings for sampling the input signal; e.g., a sampling clock A, a sampling clock B, and so on.

As such, a plurality of sampling signals, such as a sampling signal A and a sampling signal B are obtained. The sampling signals obtained from the same input signal may vary in accordance with the sampling clock being used.

In this case, the waveform shaping is carried out only when a certain condition is met, so that the pulse width falls within the reference range. For example, the certain condition can be met when a pulse width does not fall within the reference range; e.g., (i) a pulse width is longer than a predetermined pulse width, or (ii) the pulse width is less than the specified width). This allows a pulse to become close to the original waveform.

(k) Further, in order to solve the foregoing problem, a waveform shaping device of the present invention includes: sampling means for generating a sampling signal by using a sampling clock for sampling an input signal which is a pulse signal generated from an original signal through a signal processing, the sampling clock having a speed that is faster than a data speed of the input signal; waveform shaping means for processing the sampling signal so that a pulse in the input signal, recognized from the sampling signal, is shaped.

In the configuration, the sampling means generates a sampling signal by sampling the input signal with the use of the sampling clock whose speed is faster than a data speed of the input signal. In this way, a single pulse of the input signal can be indicated by plural symbols of the sampling signal. Further, it is possible to prevent the information contained in the input signal from being omitted. In other words, the sampling signal can be so generated that the information is accurately restored. Further, even if a waveform of the single pulse is distorted due to its transmission, the distortion is reduced in the sampling signal converted from the single pulse.

Further, in the foregoing configuration, the waveform shaping means is used for shaping the input signal so that the original input signal is restored. For example, the waveform shaping can be easily carried out by correcting (e.g., inverting) the pulse by using the sampling signal in which the distortion has been reduced. Accordingly, in the foregoing configuration, the original input signal is more accurately regenerated and restored through the waveform shaping or the like carried out after the transmission of the input signal.

(1) Further, in order to solve the foregoing problem, a waveform shaping device of the present invention includes: sampling means; and

waveform shaping means, wherein the sampling means samples a pulse signal at a sampling period shorter than a minimum pulse width and a minimum pulse interval in the pulse signal, so as to generate a sampling signal which is a discrete symbol string for replacing the pulse signal, the pulse signal being generated by carrying out a signal processing with respect to an original pulse signal, the waveform shaping means compares a second symbol count with an interval reference value, where (i) the first symbol count is a number of symbols in a first symbol string having been replaced for a pulse-existing period, and (ii) a second symbol count is a number of symbols in a second symbol string having been replaced for a no-pulse period adjacent to the pulse-existing period, and if the second symbol count is less than the interval reference value, the waveform shaping means partially replaces the first symbol string with the second symbol string in such a manner that the second symbol count is equal to the interval reference value, irrespective of a pulse width of the pulse signal generated through the signal processing, so as to lengthen the no-pulse period.

In the configuration, the no-pulse period is considered, and a process similar to the foregoing process which considers the pulse-existing period is carried out. In the waveform shaping focusing on the pulse-existing period, a pulse interval is lengthened by an amount that a pulse width is shortened. As such, the no-pulse period can be guaranteed. Meanwhile, in the foregoing configuration, the no-pulse period is given priority, and the waveform shaping is carried with the aim of causing all of the pulse intervals to be more than the reference interval value.

As such, if the pulse signal contains such a distortion that a pulse interval is narrowed as a result of lengthening of the pulse width or shifting of a pulse, it is possible to effectively reduce a risk of a pulse interval disappearing in a successive step of the signal processing.

(m) In order to solve the foregoing problem, an electronic device of the present invention includes: the foregoing waveform shaping device; and a receiving device for receiving a signal based on an original pulse signal, and for generating the pulse signal.

In the foregoing configuration, a distortion which causes a difference between the waveform and an original waveform of the pulse signal occurs easily, when the receiving device receives the signal based on the original pulse signal, and generates the pulse signal. When such a distortion occurs, the waveform shaping device of the present invention corrects the distortion, and makes the waveform of the pulse signal close to its original waveform. Therefore, it is possible to prevent or restrain a malfunction of the electronic device or another electronic device to which a signal obtained, based on the pulse signal, is transmitted from the electronic device.

(n) An electronic device of the present invention includes: the foregoing waveform shaping device; a remote control for generating an original pulse signal; and a receiving device for receiving a signal based on the original pulse signal, and for generating the pulse signal.

With the configuration, the above described effect obtained by using the foregoing electronic device is obtained in: (I) an electronic device which uses a remote control, such as a moving/still image displaying device, a moving/still image recording device, an information processing device, an air conditioning device, and other home-use electronic product; and (II) a wireless system or the like which is a combination of these devices.

(o) In order to solve the foregoing problem, a waveform shaping program of the present invention is for causing a computer to execute each step of the foregoing waveform shaping method.

In order to solve the foregoing problem, a waveform shaping program of the present invention is for causing a computer to function as each means of the foregoing waveform shaping device.

In order to solve the foregoing problem, a computer-readable recording medium of the present invention stores therein the foregoing waveform shaping program.

With the computer-readable recording medium, the foregoing effects can be obtained in a computer or an electronic device having the computer, by downloading to the computer, the waveform shaping program of the present invention so that the waveform shaping program of the present invention can be executed in the computer or the electronic device having the computer.

The waveform shaping method of the present invention may be realized by the waveform shaping program in which each step of at least one of the foregoing waveform shaping methods is written in an executable manner. Similarly, the waveform shaping device may be realized by the waveform shaping program that can be read by a computer, for causing a computer to function as each means of at least one of the foregoing waveform shaping devices.

Further, it is needless to say that an object of the present invention is achieved by (i) supplying, to a system or a device, a recording medium storing therein a program symbol of software for realizing the functions described in the foregoing embodiments, and (ii) causing a computer (or CPU, or MPU) of the system or the device to read out and execute the program symbol stored in the recording medium.

In this case, the present invention is the program symbol stored in the recording medium, and the functions described in the foregoing embodiments are realized by the program symbol being read out from the recording medium.

The recording medium for supplying the program symbol can be, for example, a floppy disc, a hard disc, an optical disc, a magnet-optical disk, a magnetic disc, an involatile memory card, or the like.

Further, the program symbol may be downloaded from a computer system to a memory section of a terminal via a transmission medium such as a communication network.

Further, the scope of the present invention includes (i) a case where the foregoing functions of the embodiments are realized by using a computer for reading out and executing the program symbol, as well as (ii) a case where the functions of the embodiments are realized by causing an OS (operating system) of the computer to partially or entirely carry out an actual operation on the basis of an instruction of the program symbol.

Further, the scope of the present invention also includes a case where the functions of the embodiments are realized by: (I) writing the program symbol read out from the recording medium into a memory provided in (i) a feature expansion board inserted into a computer or (ii) a feature expansion unit being connected to the computer; and (II) causing a CPU or the like provided in the feature expansion board or the feature expansion unit to entirely or partially carry out an actual operation according to an instruction of the program symbol.

When the present invention is applied to the recording medium, the aforementioned flowchart is stored in the recording medium in the form of program symbol.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

Further, an embodiment based on a proper combination of technical means disclosed in different embodiments is encompassed in the technical scope of the present invention.

### INDUSTRIAL APPLICABILITY

A waveform shaping method, a waveform shaping device, an electronic device, a waveform shaping program and a recording medium of the present invention allows a proper transmission of waveform of a pulse signal to be transmitted, with a use of a simple configuration. Accordingly, the present invention is suitably applied to a receiving section of an electronic device such as a home-use product having a remote control, or a communication device.

1-43. (canceled)

44. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal closer to a predetermined pulse width, irrespective of the pulse width.

45. The waveform shaping method as set forth in claim 44, wherein
the predetermined pulse width is standardized, irrespective of the pulse width of the input signal, taking into account a level of distortion in the pulse width, the distortion mainly attributed to the signal processing.

46. The waveform shaping method as set forth in claim 44, wherein
the predetermined pulse width is a value close to a lower limit value of a possible pulse width range of the input signal.

47. The waveform shaping method as set forth in claim 44, wherein
if the input signal contains information related to the pulse width of the input signal, the information is read out, and the predetermined pulse width is determined based on the information.

48. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that, when the input signal is a pulse signal which is generated through a signal processing carried out with respect to an original pulse signal on which the input signal is based, waveform shaping is carried out by shortening, by a predetermined value, that pulse width of the input signal which is recognized from the sampling signal, irrespective of the pulse width.

49. The waveform shaping method as set forth in claim 48, wherein
the predetermined value is determined based on (i) a lower limit value of a possible pulse width range of the input signal, and (ii) an inverse number of a sampling clock frequency, and the predetermined value is set less than the lower limit value.

50. The waveform shaping method as set forth in claim 48, wherein
if the input signal contains information related to the pulse width of the input signal, the predetermined value is set smaller than the pulse width read out from the information.

51. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that, when the input signal is a pulse signal which is generated through a signal processing carried out with respect to an original pulse signal on which the input signal is based, waveform shaping is carried out by lengthening, by a predetermined value, that pulse width of the input signal which is recognized from the sampling signal, irrespective of the pulse width.

52. The waveform shaping method as set forth in claim 48, wherein
the predetermined value is standardized, irrespective of the pulse width of the input signal, in consideration of a level of distortion in the pulse width, the distortion mainly attributed to the signal processing.

53. The waveform shaping method as set forth in claim 51, wherein
the predetermined value is standardized, irrespective of the pulse width of the input signal, in consideration of a level of distortion in the pulse width, the distortion mainly attributed to the signal processing.

54. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal closer to a minimum pulse width of the input signal in the sampling signal, irrespective of the pulse width.

55. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal equal to or smaller than a minimum pulse width of the input signal in the sampling signal, irrespective of the pulse width.

56. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal equal to an inverse number of the sampling clock frequency, irrespective of the pulse width.

57. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the waveform shaping step being such that (I) a no-pulse period, which is recognized from the sampling signal, is detected, and (II) if the no-pulse period is less than a setting value, waveform shaping is so carried out, irrespective of a pulse width, as to modify the no-pulse period to the setting value by (i) shifting a position of a pulse adjacent to the no-pulse period or (ii) shaping the pulse.

58. The waveform shaping method as set forth in claim 57, wherein
when the input signal is a pulse signal generated through a signal processing carried out with respect to an original pulse signal on which the input signal is based, the setting value is determined, taking into account a level of distortion in the pulse width, the distortion mainly attributed to the signal processing.

59. The waveform shaping method as set forth in claim 57, wherein
if the input signal contains information related to a pulse interval of the input signal, the setting value is set based on the pulse interval read out from the information.

60. The waveform shaping method as set forth in any one of claims 44, 48, 51, and 54 through 57, wherein:
in the waveform shaping step, waveform shaping is carried out by partially inverting bit string of the sampling signal.

61. The waveform shaping method as set forth in any one of claims 44, 48, 51, and 54 through 57, wherein:
in the waveform shaping step, waveform shaping is carried out by processing a part of the sampling signal, corresponding to a trailing side of the pulse in the input signal.

62. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse width recognized from the sampling signal is compared with (i) a first reference value, and (ii) a second reference value which is larger than the first reference value by a constant value, and (II) if the pulse width is equal to or larger than the second reference value, the pulse width is reduced by the constant value, irrespective of the pulse width.

63. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse width recognized from the sampling signal is compared with (i) a first reference value, and (ii) a second reference value which is larger than the first reference value by a constant value, and (II) if the pulse width is larger than the first reference value but less than the second reference value, the pulse width is reduced, irrespective of the pulse width, so that the pulse width is made as close to the first reference value as possible.

64. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse width recognized from the sampling signal is compared with (i) a first reference value, and (ii) a second reference value which is larger than the first reference value by a constant value, and (II) the pulse width is not reduced if the pulse width is equal to or less than the first reference value.

65. The waveform shaping method as set forth in claim 62, wherein
in the waveform shaping step, a pulse interval recognized from the sampling signal is compared with an interval reference value, and if the pulse interval is less than the interval reference value, the pulse interval is lengthened, irrespective of the pulse width, so that the pulse interval is made as close to the interval reference value as possible, the pulse interval being a width of a period having no pulse.

66. The waveform shaping method as set forth in claim 63, wherein
in the waveform shaping step, a pulse interval recognized from the sampling signal is compared with an interval reference value, and if the pulse interval is less than the interval reference value, the pulse interval is lengthened, irrespective of the pulse width, so that the pulse interval is made as close to the interval reference value as possible, the pulse interval being a width of a period having no pulse.

67. The waveform shaping method as set forth in claim 64, wherein
in the waveform shaping step, a pulse interval recognized from the sampling signal is compared with an interval reference value, and if the pulse interval is less than the interval reference value, the pulse interval is lengthened, irrespective of the pulse width, so that the pulse interval is made as close to the interval reference value as possible, the pulse interval being a width of a period having no pulse.

68. The waveform shaping method as set forth in claim 65, wherein
the pulse interval is lengthened by shifting a position of a pulse adjacent to the pulse interval.

69. The waveform shaping method as set forth in claim 66, wherein
the pulse interval is lengthened by shifting a position of a pulse adjacent to the pulse interval.

70. The waveform shaping method as set forth in claim 67, wherein
the pulse interval is lengthened by shifting a position of a pulse adjacent to the pulse interval.

71. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse interval recognized from the sampling signal is compared with an interval reference value, and (II) if the pulse interval is less than the interval reference value, the pulse interval is lengthened, irrespective of a pulse width, by (i) shifting a position of a pulse adjacent to the no-pulse period or (ii) shaping the pulse so that the pulse interval is made as close to the interval reference value as possible, the pulse interval being a width of a period having no pulse.

72. The waveform shaping method as set forth in claim 71, wherein
in the waveform shaping step, a pulse width recognized from the sampling signal is compared with a first reference value, and with a second reference value which is larger than the first reference value by a constant value; and
if the pulse width is equal to or larger than the second reference value, the pulse width is reduced by the constant value, irrespective of the pulse width.

73. The waveform shaping method as set forth in claim 71, wherein
if the pulse width is larger than the first reference value but less than the second reference value, the pulse width is reduced, so that the pulse width is made as close to the first reference value as possible.

74. The waveform shaping method as set forth in claim 71, wherein
the pulse width is not reduced if the pulse width is equal to or less than the first reference value.

75. The waveform shaping method as set forth in any one of claims 65 through 67, or 71, wherein
the interval reference value is determined, taking into account a level of distortion in a pulse width, the distortion mainly attributed to the signal processing.

76. The waveform shaping method as set forth in any one of claims 65 through 67, or 71, wherein
if the input signal contains information related to the pulse interval of the input signal, the interval reference value is set based on the pulse interval read out from the information.

77. The waveform shaping method as set forth in any one of claims 62 through 64, wherein
the first reference value is a value close to a lower limit value of a possible pulse width range.

78. The waveform shaping method as set forth in any one of claims 62 through 64, wherein
if the input signal contains information related to the pulse width of the input signal, the information is read out, and the first reference value is determined based on the information.

79. The waveform shaping method as set forth in any one of claims 62 through 64, wherein
the constant value is determined based on (i) a lower limit value of a possible pulse width range of the input signal, and (ii) an inverse number of a sampling clock frequency, and the constant value is set less than the lower limit value.

80. The waveform shaping method as set forth in any one of claims 62 through 64, wherein
if the input signal contains information related to the pulse width of the input signal, the constant value is set smaller than the pulse width read out from the information.

81. A waveform shaping method comprising:
a sampling step for generating a sampling signal by sampling an input signal using a sampling clock which is faster than a data speed of the input signal; and
a waveform shaping step for processing the sampling signal, so that a pulse in the input signal, recognized from the sampling signal, is shaped, wherein
the input signal being a pulse signal, of a fixed-pulse-width method, being generated through a signal processing carried out with respect to an original pulse signal on which the input signal is based,
the waveform shaping step being such that (I) a width of the pulse in the input signal is compared with a reference range determined in accordance with the width of the pulse, and (II) if the width of the pulse is out of the reference range, waveform shaping is so carried out as to make the width of the pulse fall within the reference range.

82. The waveform shaping method as set forth in claim 48 or 51, wherein
the waveform shaping of the pulse width by the predetermined value is carried out only with respect to a rising portion of the pulse of the input signal, or only with respect to a falling portion of the pulse of the input signal.

83. The waveform shaping method as set forth in claim 62, wherein
the reduction of the pulse width by the constant value is carried out only with respect to a rising portion of the pulse of the input signal, or only with respect to a falling portion of the pulse of the input signal.

84. A waveform shaping device comprising:
sampling means; and
waveform shaping means, wherein
the sampling means samples a pulse signal at a sampling period shorter than a minimum pulse width and a minimum pulse interval in the pulse signal, so as to generate a sampling signal which is a discrete symbol string for replacing the pulse signal, the pulse signal being generated by carrying out a signal processing with respect to an original pulse signal,
the waveform shaping means compares a first symbol count with a first reference value and a value which is a constant value larger than the first reference value, where (i) the first symbol count is a number of symbols in a first symbol string having been replaced for a pulse-existing period, and (ii) a second symbol count is a number of symbols in a second symbol string having been replaced for a no-pulse period adjacent to the pulse-existing period, and
if the first symbol count is equal to or more than the second reference value, the waveform shaping means partially replaces the first symbol string with the second symbol string by the constant value, irrespective of a pulse width of the pulse signal generated through the signal processing, so as to shorten the pulse-existing period.

85. A waveform shaping device comprising:
sampling means; and
waveform shaping means, wherein
the sampling means samples a pulse signal at a sampling period shorter than a minimum pulse width and a minimum pulse interval in the pulse signal, so as to generate a sampling signal which is a discrete symbol string for replacing the pulse signal, the pulse signal being generated by carrying out a signal processing with respect to an original pulse signal,
the waveform shaping means compares a second symbol count with an interval reference value, where (i) the first symbol count is a number of symbols in a first symbol string having been replaced for a pulse-existing period, and (ii) a second symbol count is a number of symbols in a second symbol string having been replaced for a no-pulse period adjacent to the pulse-existing period, and
if the second symbol count is less than the interval reference value, the waveform shaping means partially replaces the first symbol string with the second symbol string in such a manner that the second symbol count is equal to the interval reference value, irrespective of a pulse width of the pulse signal generated through the signal processing, so as to lengthen the no-pulse period.

86. An electronic device comprising:
the waveform shaping device set forth in claim 84 or 85; and a receiving device for receiving a signal based on an original pulse signal, and for generating the pulse signal.

87. An electronic device comprising:
the waveform shaping device set forth in claim 84 or 85;
a remote control for generating an original pulse signal; and
a receiving device for receiving a signal which is output from the remote control based on the original pulse signal, and for generating the pulse signal.

88. A waveform shaping program for causing a computer to execute steps included in a waveform shaping method,
wherein:
the waveform shaping method includes:
a sampling step for generating a sampling signal by sampling an input signal using a sampling clock which is faster than a data speed of the input signal; and
a waveform shaping step for processing the sampling signal, so that a pulse in the input signal recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal closer to a predetermined pulse width, irrespective of the pulse width.

89. A waveform shaping program for causing a computer to execute steps included in a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the waveform shaping step being such that, when the input signal is a pulse signal which is generated through a signal processing carried out with respect to an original pulse signal on which the input signal is based, waveform shaping is carried out by shortening, by a predetermined value, that pulse width of the input signal which is recognized from the sampling signal, irrespective of the pulse width.

90. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the waveform shaping step being such that, when the input signal is a pulse signal which is generated through a signal processing carried out with respect to an original pulse signal on which the input signal is based, waveform shaping is carried out by lengthening, by a predetermined value, that pulse width of the input signal which is recognized from the sampling signal, irrespective of the pulse width.

91. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal closer to a minimum pulse width of the input signal in the sampling signal, irrespective of the pulse width.

92. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal equal to or smaller than a minimum pulse width of the input signal in the sampling signal, irrespective of the pulse width.

93. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the waveform shaping step being such that, when the input signal is a pulse signal for use in a fixed-pulse-width method, the pulse signal being generated through a signal processing carried out with respect to an original pulse signal on which the input signal is based, waveform shaping is carried out by making that pulse width of the input signal which is recognized from the sampling signal equal to an inverse number of the sampling clock frequency, irrespective of the pulse width.

94. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the waveform shaping step being such that (I) a no-pulse period, which is recognized from the sampling signal, is detected, and (II) if the no-pulse period is less than a setting value, waveform shaping is so carried out, irrespective of a pulse width, as to modify the no-pulse period to the setting value by (i) shifting a position of a pulse adjacent to the no-pulse period or (ii) shaping the pulse.

95. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse width recognized from the sampling signal is compared with (i) a first reference value, and (ii) a second reference value which is larger than the first reference value by a constant value, and (II) if the pulse width is equal to or larger than the second reference value, the pulse width is reduced by the constant value, irrespective of the pulse width.

96. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse width recognized from the sampling signal is compared with (i) a first reference value, and (ii) a second reference value which is larger than the first reference value by a constant value, and (II) if the pulse width is equal to or larger than the second reference value, the pulse width is reduced by the constant value, irrespective of the pulse width.

97. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse width recognized from the sampling signal is compared with (i) a first reference value, and (ii) a second reference value which is larger than the first reference value by a constant value, and (II) the pulse width is not reduced if the pulse width is equal to or less than the first reference value.

98. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the input signal being a pulse signal generated through a signal processing carried out with respect to an original pulse signal on which the input signal is based,
the waveform shaping step being such that (I) a pulse interval recognized from the sampling signal is compared with an interval reference value, and (II) if the pulse interval is less than the interval reference value, the pulse interval is lengthened, irrespective of a pulse width, by (i) shifting a position of a pulse adjacent to the no-pulse period or (ii) shaping the pulse so that the pulse interval is made as close to the interval reference value as possible, the pulse interval being a width of a period having no pulse.

99. A waveform shaping program for causing a computer to execute the steps of a waveform shaping method,
wherein:
the waveform shaping method includes:
the sampling step for generating a sampling signal by sampling an input signal using a sampling clock which is faster than a data speed of the input signal; and
the waveform shaping step for processing the sampling signal, so that a pulse in the input signal, recognized from the sampling signal, is shaped,
the input signal being a pulse signal, of a fixed-pulse-width method, being generated through a signal processing carried out with respect to an original pulse signal on which the input signal is based,
the waveform shaping step being such that (I) a width of the pulse in the input signal is compared with a reference range determined based on the width of the pulse, and (II) if the width of the pulse is out of the reference range, waveform shaping is so carried out as to make the width of the pulse fall within the reference range.

100. A waveform shaping program for causing a computer to function as means of a waveform shaping device, wherein:
the waveform shaping device includes:
sampling means; and
waveform shaping means, wherein
the sampling means samples a pulse signal at a sampling period shorter than a minimum pulse width and a minimum pulse interval in the pulse signal, so as to generate a sampling signal which is a discrete symbol string for replacing the pulse signal, the pulse signal being generated by carrying out a signal processing with respect to an original pulse signal,
the waveform shaping means compares a first symbol count with a first reference value and a second reference value which is a constant value larger than the first reference value, where (i) the first symbol count is a number of symbols in a first symbol string having been replaced for a pulse-existing period, and (ii) a second symbol count is a number of symbols in a second symbol string having been replaced for a no-pulse period adjacent to the pulse-existing period, and
if the first symbol count is equal to or more than the second reference value, the waveform shaping means partially replaces the first symbol string with the second symbol string by the constant value, irrespective of a pulse width of the pulse signal generated through the signal processing, so as to shorten the pulse-existing period.

101. A waveform shaping program for causing a computer to function as means of a waveform shaping device, wherein:
the waveform shaping device includes:
sampling means; and
waveform shaping means, wherein
the sampling means samples a pulse signal at a sampling period shorter than a minimum pulse width and a minimum pulse interval in the pulse signal, so as to generate a sampling signal which is a discrete symbol string for replacing the pulse signal, the pulse signal being generated by carrying out a signal processing with respect to an original pulse signal,
the waveform shaping means compares a second symbol count with an interval reference value, where (i) the first symbol count is a number of symbols in a first symbol string having been replaced for a pulse-existing period, and (ii) a second symbol count is a number of symbols in a second symbol string having been replaced for a no-pulse period adjacent to the pulse-existing period, and
if the second symbol count is less than the interval reference value, the waveform shaping means partially replaces the first symbol string with the second symbol string in such a manner that the second symbol count is equal to the interval reference value, irrespective of a pulse width of the pulse signal generated through the signal processing, so as to lengthen the no-pulse period.
